(19) United States
(12) Patent Application Publication
(10) Pub. No.: US 2017/0323330 A1
(43) Pub. Date: Nov. 9, 2017

(54) MEDIA SPEND MANAGEMENT USING REAL-TIME PREDICTIVE MODELING OF TOUCHPOINT EXPOSURE EFFECTS

(71) Applicants: Anto Chittilappilly, Waltham, MA (US); Payman Sadegh, Alpharetta, GA (US)

(72) Inventors: Anto Chittilappilly, Waltham, MA (US); Payman Sadegh, Alpharetta, GA (US)

(21) Appl. No.: 15/490,751

(22) Filed: Apr. 18, 2017

Related U.S. Application Data
(60) Provisional application No. 62/325,160, filed on Apr. 20, 2016.

(51) Int. Cl. G06Q 30/02; G06N 99/00

(52) U.S. Cl. CPC G06Q 30/0244; G06N 99/005; G06Q 30/0277

(57) ABSTRACT

A touchpoint exposure predictive model defines the relationship between a number of messages deployed in a message campaign and the response so as to model diminishing returns on the response due to the number of messages. A predicted message deployment—response curve is rendered on a display of a user computer depicts the effectiveness of the response to the messages. The user runs a simulation to increase the number of the messages in the campaign, and a modified message deployment—response curve for the messages, which incorporates diminishing returns, is rendered from the touchpoint exposure predictive model.

### RELATED APPLICATIONS

The present application claims the benefit of priority to co-pending U.S. Provisional Patent Application Ser. No. 62/325,160, entitled “Improving Media Spend Management Using Real-time Predictive Modeling of Touchpoint Exposure Effects” (Attorney Docket No. VISQ P0022P), filed Apr. 20, 2016, which is hereby expressly incorporated by reference in its entirety.

### FIELD OF THE INVENTION

The disclosure relates to the field of machine learning for predictive modeling of cause and effect, and more particularly, to techniques for improving media spend management using real-time predictive modeling of touchpoint exposure effects.

### BACKGROUND

The prevalence of Internet or online advertising and marketing continues to grow at a fast pace. Today, an online user (e.g., prospect) in a given target audience can experience a high number of exposures to a brand and product (e.g., touchpoints) across multiple digital media channels (e.g., display, paid search, paid social, etc.) on the journey to conversion (e.g., buying a product, etc.) and/or to some other engagement state (e.g., brand introduction, brand awareness, etc.). Further, another online user in the same target audience might experience a different combination or permutation of touchpoints and channels, but might not convert. Large volumes of data characterizing the user interactivity with such a high number of touchpoints is continuously collected in various forms (e.g., touchpoint attribute records, cookies, log files, pixel tags, mobile tracking, etc.) by the online advertising ecosystem using today's always on, always connected Internet technology. The marketing manager of today desires to use this continuous stream of touchpoint data to learn exactly what touchpoints contributed the most to conversions (e.g., touchpoint attribution) in order to develop media spend scenarios and plans that allocate the marketing budget to those tactics.

Certain “bottom-up” touchpoint response predictive modeling techniques can collect user level stimulus and response data (e.g., touchpoint attribute data, conversion data, etc.) to assign conversion credit to every touchpoint and touchpoint attribute (e.g., ad size, placement, publisher, creative, offer, etc.) experienced by even/ converting user and non-converting user across all channels. For example, such techniques can predict the contribution value of a given touchpoint for a given segment of users and/or media channels. The marketing manager can use such predicted touchpoint contribution values to develop an intra-channel (e.g., touchpoint) media spend plan. In some cases, the marketing manager might allocate certain levels of spend to a particular set of touchpoints so as to affect the relative contribution value of the touchpoints. For example, a given touchpoint might exhibit non-linear touchpoint exposure characteristics (e.g., reach, frequency, etc.) such that incremental spending on that touchpoint might also yield a non-linear response and corresponding contribution value. Unfortunately, the foregoing touchpoint response predictive models are limited at least in their ability to model such dynamic touchpoint exposure effects.

Techniques are needed to address the problem of estimating the effect an advertiser's purchase of certain touchpoints has on the performance (e.g., ROI) of the touchpoints.

None of the aforementioned legacy approaches achieve the capabilities of the herein-disclosed techniques for improving media spend management using real-time predictive modeling of touchpoint exposure effects. Therefore, there is a need for improvements.

### BRIEF DESCRIPTION OF THE DRAWINGS

FIG. 1A depicts techniques for improving media spend management using real-time predictive modeling of touchpoint exposure effects, according to an embodiment.

FIG. 1B shows an environment in which embodiments of the present disclosure can operate.

FIG. 2 depicts an environment in which embodiments of the present disclosure can operate.

FIG. 3A presents a touchpoint response predictive modeling technique used in systems for improving media spend management using real-time predictive modeling of touchpoint exposure effects, according to some embodiments.

FIG. 3B presents a touchpoint attribute chart showing sample attributes associated with touchpoints of a media campaign, according to some embodiments.

FIG. 3C illustrates a touchpoint attribution technique, according to some embodiments.

FIG. 4A depicts a user interaction environment for selecting and viewing predicted performance results of a media spend plan.

FIG. 4B is a depiction of media spend plan performance results plotted in an interactive interface.

FIG. 5A illustrates a non-linear touchpoint exposure curve.

FIG. 5B presents a non-linear touchpoint ROI curve that illustrates non-linear touchpoint exposure effects on touchpoint ROI, according to some embodiments.

FIG. 6A presents a touchpoint exposure predictive modeling technique used in systems for improving media spend management using real-time predictive modeling of touchpoint exposure effects, according to some embodiments.

FIG. 6B presents a touchpoint exposure effect, feedback application technique used in systems for improving media spend management using real-time predictive modeling of touchpoint exposure effects, according to some embodiments.

FIG. 7A depicts a user interaction environment, for selecting and viewing predicted performance results of a media spend plan in systems for improving media spend management using real-time predictive modeling of touchpoint exposure effects, according to some embodiments.

FIG. 7B depicts a set of media spend plan performance results plotted in an interactive interface as implemented in systems for improving media spend management using real-time predictive modeling of touchpoint exposure effects, according to some embodiments.

FIG. 8A depicts a subsystem for improving media spend management using real-time predictive modeling of touchpoint exposure effects, according to some embodiments.

FIG. 8B presents a flow chart for improving media spend management using real-time predictive modeling of touchpoint exposure effects, according to some embodiments.

FIG. 9A is a block diagram of a system for improving media spend management using real-time predictive modeling of touchpoint exposure effects, according to an embodiment.

FIG. 10A and FIG. 10B depict block diagrams of computer system components suitable for implementing embodiments of the present disclosure.

### DETAILED DESCRIPTION

### Overview

Certain “bottom-up” touchpoint response predictive modeling techniques can collect user level stimulus and response data (e.g., touchpoint attribute data, conversion data, etc.) to assign conversion credit to every touchpoint and touchpoint attribute (e.g., ad size, placement, publisher, creative, offer, etc.) experienced by every converting user and non-converting user across all channels. For example, such techniques can predict the contribution value of a given touchpoint for a given segment of users and/or for a given set of media channels. The marketing manager can use such predicted touchpoint contribution values to develop an intra-channel (e.g., touchpoint) media spend plan. In some cases, the marketing manager might allocate certain levels of spend to a particular set of touchpoints so as to affect the modeled contribution value of the touchpoints. For example, a given touchpoint might exhibit non-linear touchpoint exposure characteristics (e.g., reach, frequency, etc.) such that incremental spending on that touchpoint might also yield a non-linear response and corresponding contribution value.

Disclosed herein is a closed loop feedback system for dynamically transmitting media buy touchpoint parameters (e.g., characterizing one or more touchpoint buys from a media spend plan) to a touchpoint exposure predictive model to estimate in real time the effect of the touchpoint buys on the performance of the media spend plan. The system updates in real time the estimated performance of the media spend plan responsive to a change in touchpoint contribution values based in part on the touchpoint buys associated with the media spend allocations selected by a marketing manager. The media spend allocation options and the real-time media spend performance can be presented to the marketing manager by a media planning application.

Further details regarding a general approach to bottom up touchpoint attribution are described in U.S. application Ser. No. 13/492,493 (Attorney Docket No. VISQ P0003) entitled, “A METHOD AND SYSTEM FOR DETERMINING TOUCHPOINT ATTRIBUTION”, filed Jun. 8, 2012, the contents of which are incorporated by reference in its entirety in this Application.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

### Solutions Rooted in Technology

The appended figures corresponding to the discussions given herein provide sufficient disclosure to make and use systems, methods, and computer program products that address the aforementioned issues with legacy approaches. More specifically, the present disclosure provides a detailed description of techniques used in systems, methods, and in computer program products for improving media spend management using real-time predictive modeling of touchpoint exposure effects. Certain embodiments are directed to technological solutions for delivering allocated touchpoint buy parameters characterizing one or more touchpoint buys from a media spend plan to a touchpoint exposure predictive model to estimate in real time the effect of the touchpoint buys on the performance of the media spend plan, which embodiments advance the relevant technical fields, as well as advancing peripheral technical fields.

The disclosed embodiments modify and improve over legacy approaches. In particular, the herein-disclosed techniques provide technical solutions that address the technical problems attendant to estimating the effect an advertiser's purchase of certain touchpoints has on the performance (e.g., ROI) of the touchpoints. The herein disclosed technical solutions collect information generated while using Internet-deployed applications (e.g., browsers). The collected information is used in machine learning models, and dynamically generated results are emitted from multiple of such machine learning models. Some embodiments disclosed herein use techniques to improve the functioning of multiple systems within the disclosed environments, and some embodiments advance peripheral technical fields as well.

Reference is now made in detail to certain embodiments. The disclosed embodiments are not intended to be limiting of the claims.

### DESCRIPTIONS OF EXEMPLARY EMBODIMENTS

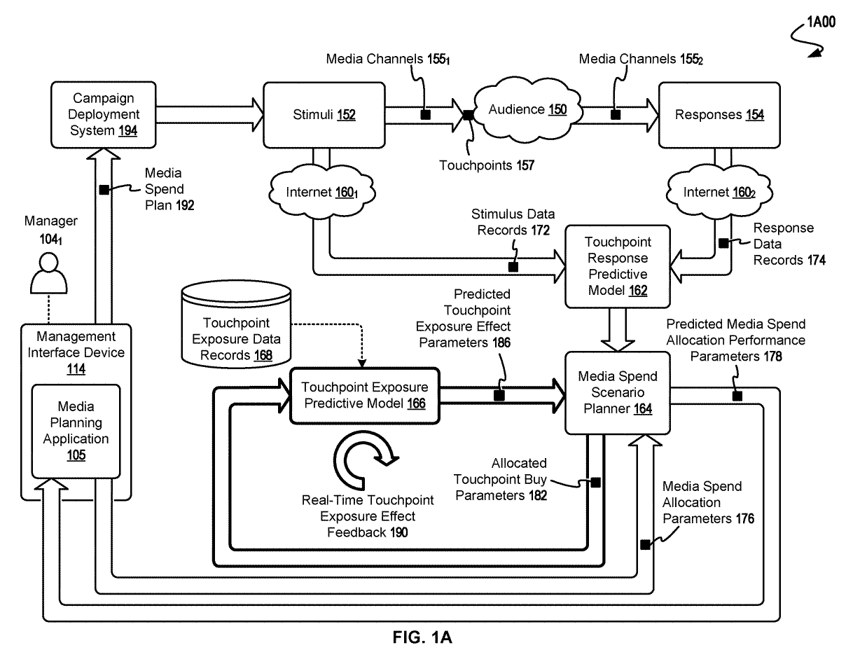

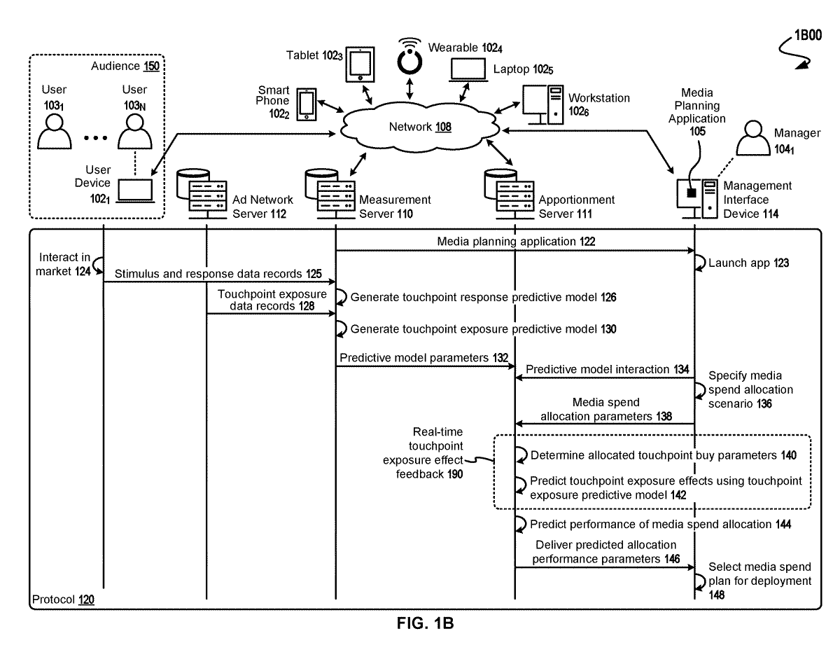

FIG. 1A depicts techniques 1A00 for improving media spend management using real-time predictive modeling of touchpoint exposure effects. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a marketing campaign) that further produces a set of responses 154. For example, the stimuli 152 might be part of a marketing campaign developed by a marketing manager (e.g., manager 94₁) to reach the audience 150 with the objective to generate user conversions (e.g., sales of a certain product). The stimuli 152 is delivered to the audience 150 through certain instances of media channels 155₁ that can comprise digital or online media channels (e.g., online display, online search, paid social media, email, etc.). The media channels 155₁ can further comprise non-digital or offline media channels (e.g., TV, radio, print, etc.). The audience 150 is exposed to each stimulation comprising the stimuli 152 through a set of touchpoints 157 characterized by certain respective attributes. The responses 154 can also be delivered through other instances of media channels 155₂ that can further comprise online and offline media channels. In some cases, the information indicating a particular response can be included in the attribute data associated with the instance of touchpoints 157 to which the user is responding. The portion of stimuli 152 delivered through online media channels can be received by the users comprising audience 150 at various instances of user devices (e.g., mobile phone, laptop computer, desktop computer, tablet, etc.). Further, the portion of responses 154 received through digital media channels can also be invoked by the users comprising audience 150 using the user devices.

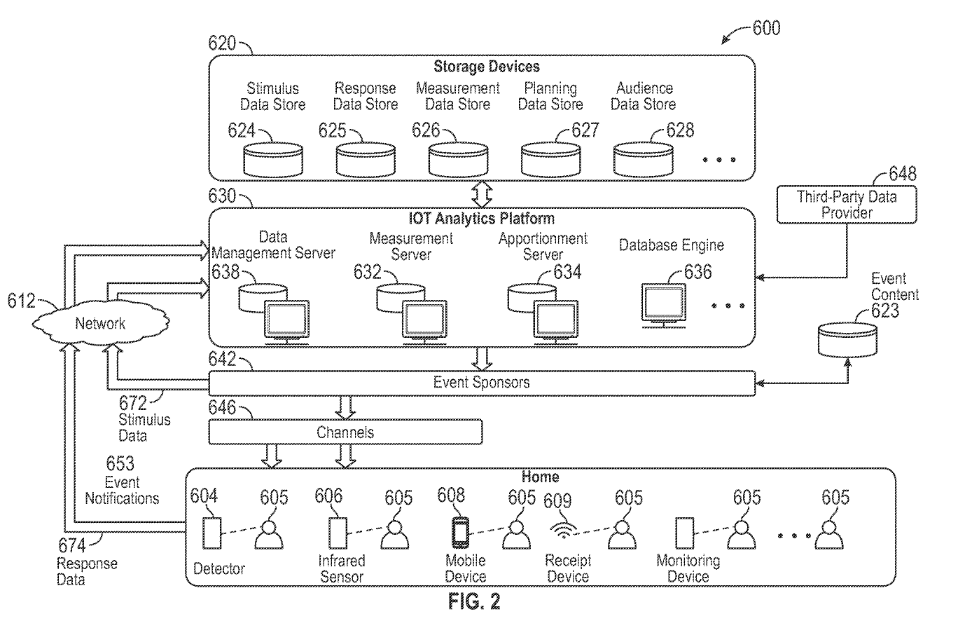

As further shown, a set of stimulus data records 172 and a set of response data records 174 can be received over a network (e.g., see Internet 160₁ and Internet 160₂) to be used to generate a touchpoint response predictive model 162. The touchpoint response predictive model 162 can be used to estimate the effectiveness of each stimulus in a certain marketing campaign by attributing conversion credit (e.g., contribution value) to the various stimuli comprising the campaign. More specifically, touchpoint response predictive model 162 can be used to estimate the attribution (e.g., contribution value) of each stimulus and/or group of stimuli (e.g., a channel from the media channels 155₁) to the conversions comprising the response data records 174. The touchpoint response predictive model 162 can be formed using any machine learning techniques (e.g., see FIG. 2A) to accurately model the relationship between the stimuli 152 and the responses 154. For example, weekly summaries of the stimulus data records 172 and the response data records 174 over a certain historical period (e.g., last six months) can be used to generate the touchpoint response predictive model 162. When formed, the touchpoint response predictive model 162 can be described in part by certain model parameters (e.g., input variables, output variables, equations, equation coefficients, mapping relationships, limits, constraints, etc.).

A media spend scenario planner 164 might be used in combination with the touchpoint response predictive model 162 to enable the manager 104₁ to select a media spend allocation plan for a given marketing campaign. For example, the manager 104₁ can access the media spend scenario planner 164 using a media planning application 105 operating on a management interface device 114 (e.g., laptop computer) to test various media spend allocation scenarios. For example, a media spend allocation scenario might allocate a media spend budget among a digital search channel, a digital display channel, a TV channel, and/or a radio channel. Higher and/or lower levels of allocation granularity are possible. For a given media spend allocation scenario characterized by a set of media spend allocation parameters 176, the media scenario spend planner 164 can generate a set of predicted media spend allocation performance parameters 178 corresponding to a predicted performance (e.g., conversions, ROI, other performance metrics, etc.) of the media spend allocation scenario to be used in presenting such a response and/or performance to the manager 104₁ in the media planning application 105. The manager 104₁ can compare various media spend allocation scenarios to select a media spend plan 192 for deployment to the audience 150 by a campaign deployment system 194.

In some cases, the manager 104₁ might want to know the effect the purchase of certain touchpoints associated with a given media spend allocation scenario has on the performance (e.g., ROI) of the touchpoint spend and/or the overall media spend allocation scenario. The herein disclosed techniques provide a technological solution for the manager 104₁ by implementing a real-time touchpoint exposure effect feedback 190. Specifically, in one or more embodiments, a set of allocated touchpoint buy parameters 182 (e.g., channel, publisher, quantity, etc.) can be determined in part from the media spend allocation parameters 176 and applied to a touchpoint exposure predictive model 166. In some embodiments, the touchpoint exposure predictive model 166 can be formed in part using a set of touchpoint exposure data records 168 (e.g., historical touchpoint data from ad networks, demand side platforms, data management platforms, etc.). By applying the allocated touchpoint buy parameters 182 to the touchpoint exposure predictive model 166, a set of predicted touchpoint exposure effect parameters 186 (e.g., touchpoint exposure curves, etc.) can be produced. The predicted touchpoint exposure effect parameters 186 can be fed back into the media spend scenario planner 164 in real time to include any touchpoint buy effects in the predicted media spend allocation performance parameters 178 delivered to the media planning application 105 for viewing by the manager 104₁. In such cases, the real-time touchpoint exposure effect feedback 190 enables any touchpoint buy effects to be included in the performance metrics of a given media spend scenario such that the manager 104₁ can make a better informed (e.g., more accurate) selection of the media spend plan 192.

The herein-disclosed technological solution described by the techniques 1A00 in FIG. 1A can be implemented in various network computing environments and associated online and offline marketplaces. Such an environment is discussed as pertains to FIG. 1B.

FIG. 1B shows an environment 1B00 in which embodiments of the present disclosure can operate. As an option, one or more instances of environment 1B00 or any aspect thereof may be implemented in the context of the architecture and functionality of the embodiments described herein. Also, the environment 1R00 or any aspect thereof may be implemented in any desired environment.

As shown in FIG. 1B, the environment 1R00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1R00 comprises at least one instance of a measurement server 110, at least one instance of an apportionment server 111, at least one instance of a message network server 112 (e.g., ad network server), and at least one instance of the management interface device 114. The servers and devices shown, in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof. In one or more embodiments, the message network server 112 can represent an “ad network” component in an online advertising ecosystem that, might aggregate media inventory and package it into buys based on context or audience. Such ad networks can help publishers reach the dispersed pool of advertisers and/or advertising agencies buying the media. The ad networks can further help with media selection, placement quality, ad serving, and/or other operations.

The environment 1B00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 1021 can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 150. Also, as earlier described in FIG. 1A, the media planning application 105 can be operating on the management interface device 114 and accessible by the manager 104₁.

As shown, the user 103₁, the user device 102₁ (e.g., operated by user 103_{N}), the measurement server 110, the apportionment server 111, the message network server 112, and the management interface device 114 (e.g., operated by the manager 1041) can exhibit a set of high-level interactions (e.g., operations, messages, etc.) in a protocol 120. Specifically, the protocol, can represent interactions in systems for improving media spend management using real-time predictive modeling of touchpoint exposure effects. As shown, the manager 104₁ can download the media planning application 105 from the measurement server 110 to the management interface device 114 (see message 122) and launch the application (see operation 123). Users in audience 150 can also interact with various marketing campaign stimuli delivered through certain media channels (see operation 124), such as taking one or more measureable actions in response to such stimuli and/or other non-media effects.

Information characterizing the stimuli and responses of the audience 150 can be collected as stimulus data records (e.g., stimulus data records 172) and response data records (e.g., response data records 174) by the measurement server 110 (see message 125). Using the stimulus and response data, the measurement server 110 can generate a stimulus attribute predictive model (see operation 126), such as touchpoint response predictive model 162. The measurement server 110 can further collect touchpoint exposure data records (see message 128) from various data sources in the ad ecosystem, such as the message network server 112. The measurement server 110 can use such touchpoint exposure data records to generate a touchpoint exposure predictive model (see operation 130), such as touchpoint exposure predictive model 166. The model parameters characterizing the aforementioned generated predictive models can be availed to the apportionment server 111 (see message 132).

The manager 104₁ can further use the media planning application 105 on the management interface device 114 to interact with the predictive models (see message 134) to specify a media spend allocation scenario (see operation 136). for example, the manager 104₁ can view the predicted contribution values for the touchpoints and/or channels of a given marketing campaign to facilitate selection and/or specification of the media spend scenario, which predicted contribution values derive from the touchpoint response predictive model. The specified media spend allocation scenario can be characterized by media spend allocation parameters that can be sent to the apportionment server 111 (see message 138) for simulation (e.g., by the media spend scenario planner 164). In some cases, the manager 104₁ might want to know the effect the purchase of certain touchpoints associated with the media spend allocation scenario has on the performance (e.g., ROI) of the touchpoint buy and/or the overall media spend allocation scenario. Strictly as one example, a given touchpoint might exhibit non-linear touchpoint exposure characteristics (e.g., reach characteristics, frequency characteristics, etc.) such that incremental spending on that touchpoint might also yield a non-linear response and corresponding contribution value that might be different as compared to the predicted contribution value.

The herein disclosed techniques provide a technological solution by implementing the real-time touchpoint exposure effect feedback 190 in the shown subset of operations in the protocol 120. The apportionment server 111 can determine a set of allocated touchpoint buy parameters from the media spend allocation parameters using any of the aforementioned techniques (see operation 140). For example, the media spend allocation parameters can be provided as inputs to the touchpoint response predictive model parameters to apportion channel spend allocations pertaining to a set of allocated touchpoint buy parameters. In this and other example scenarios, the allocated touchpoint buy parameters serve to describe intra-channel (e.g., touchpoint) buy apportionment over a given time period. Also, in this and other examples, even though allocated touchpoint buy parameters have been calculated or modeled, a marketing manager might want to manually adjust or manually influence channel spend allocations (e.g., using user interfaces provided in a scenario planner). Further details related to allocating marketing spend to touchpoints over time are shown and described as pertaining to FIG. 2A.

In some observed scenarios the predictive model might suggest touchpoint-specific diminishing returns and/or synergies and/or other effects pertaining to touchpoint exposure. In such scenarios, the allocated touchpoint buy parameters can then be applied to the touchpoint exposure predictive model to predict any touchpoint exposure effects associated with the specific media spend allocation scenario (see operation 142). Such touchpoint exposure effects can then be used by the apportionment server 111 to predict the performance (e.g., conversions, ROI, etc.) of the media spend allocation scenario (see operation 144). A set of predicted allocation performance parameters associated with the media spend allocation scenario performance can be delivered to the management interface device 114 in real time (see message 146) to enable the manager 104₁ to select a media spend plan (e.g., media spend plan 192) for deployment (see operation 148).

As shown in FIG. 1B, the techniques disclosed herein address the problems attendant to estimating the effect an advertiser's purchase of certain touchpoints has on the performance (e.g., ROI) of the touchpoints, and/or the overall media spend allocation scenario, in part, by applying the results from the real-time touchpoint exposure effect feedback 190 to a touchpoint response predictive model (e.g., touchpoint response predictive model 162). More details pertaining such touchpoint response predictive models are discussed in the following and herein.

### Internet of Things System Embodiments

FIG. 2 depicts an environment 600 in which embodiments of the present disclosure can operate. As an option, one or more instances of environment 600 or any aspect thereof may be implemented in the context of the architecture and functionality of the embodiments described herein. Also, the environment 600 or any aspect thereof may be implemented in any desired environment.

The present invention has application for systems that utilize the Internet of Things (IOT). For these embodiments, systems communicate to environments, such as a home environment, to employ event campaigns that use stimuli to effectuate desired user responses. Specifically, devices may be placed in the home to both communicate event messages or notifications as well as receive responses, either responses gathered by sensing users or by direct input to electronic devices by the users. Embodiments for implementing the present invention in such an environment are shown in FIG. 2.

The shown environment 600 depicts a set of users (e.g., user 605₁, user 605₂, user 605₃, user 605₄, user 605₅, to user 605_{N}) comprising an audience 610 that might be targeted by one or more event sponsors 642 in various event campaigns. The users may view a plurality of event notifications (messages) 653 on a reception device 609 (e.g., desktop PC, laptop PC, mobile device, wearable, television, radio, etc.). The event notifications 653 can be provided by the event sponsors 642 through any of a plurality of channels 746 in the wired environment (e.g., desktop PC, laptop PC, mobile device, wearable, television, radio, print, etc.). Stimuli from the channels 646 comprise instances of touchpoint encounters 660 experienced by the users. As an example, a TV spot may be viewed on a certain TV station (e.g., touchpoint T1), and/or a print message (e.g., touchpoint T2) in a magazine. Further, the stimuli channels 746 might present to the users a banner ad on a mobile browser (e.g., touchpoint T3), a sponsored website (e.g., touchpoint T4), and/or an event notification in an email message (e.g., touchpoint T5). The touchpoint encouters 660 can be described by various touchpoint attributes, such as data, time, campaign, event, geography, demographics, impressions, cost, and/or other attributes.

According to one implementation, an IOT analytics platform 630 can receive instances of stimulus data 672 (e.g., stimulus touchpoint attributes, etc.) and instances of response data 674 (e.g., response measurement attributes, etc.) via network 612, describing, in part, the measured responses of the users to the delivered stimulus (e.g., touchpoints 660). The measure responses are derived from certain user interactions as sensed in the home (e.g., detector 604, sensor/infrared sensor 606, or monitoring device 611) or transmitted by the user (e.g., mobile device 611, etc.) performed by certain users and can be described by various response attributes, such as data, time, response channel, event, geography, revenue, lifetime value, and other attributes. A third-party data provider 648 can further provide data, (e.g., user behaviors, user demographics, cross-device mapping, etc.) to the IOT analytics platform 630. The collected data and any associated generated data can be stored in one or more storage devices 620 (e.g., stimulus data store 624, response data store 625, measurement data store 626, planning data store 627, audience data store 628, etc.), which are made accessible by a database engine 636 (e.g., query engine, result processing engine, etc.) to a measurement server 632 and an apportionment server 634. Operations performed by the measurement server 632 and the apportionment server 634 can vary widely by embodiment. As an example, the measurement server 632 can be used to analyze certain data records stored in the stimulus data store 624 and response data store 625 to determine various performance metrics associated with an event campaign, storing such performance metrics and related data in measurement data store 626. Further, for example, the apportionment server 634 may be used to generate event campaign plans and associated event spend apportionment, storing such information in the planning data store 627.

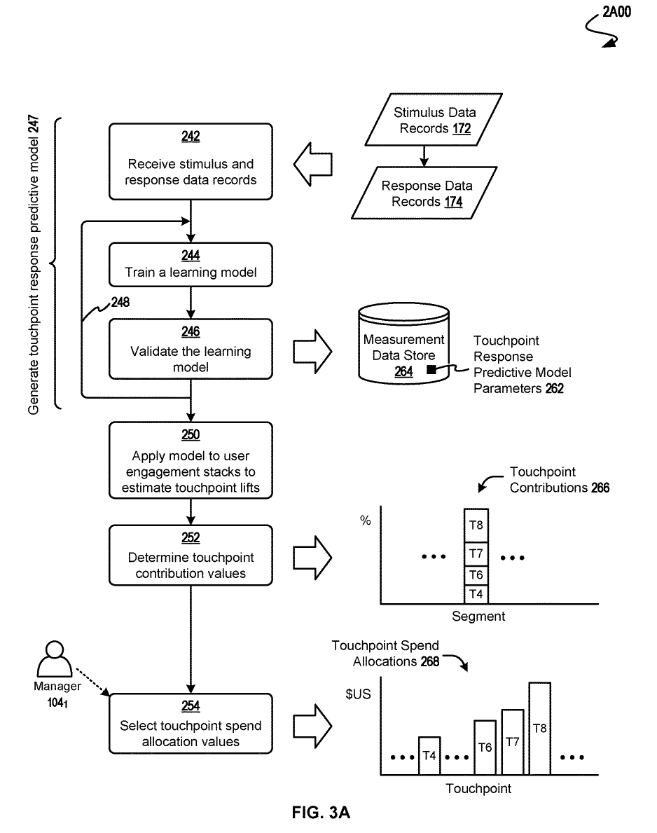

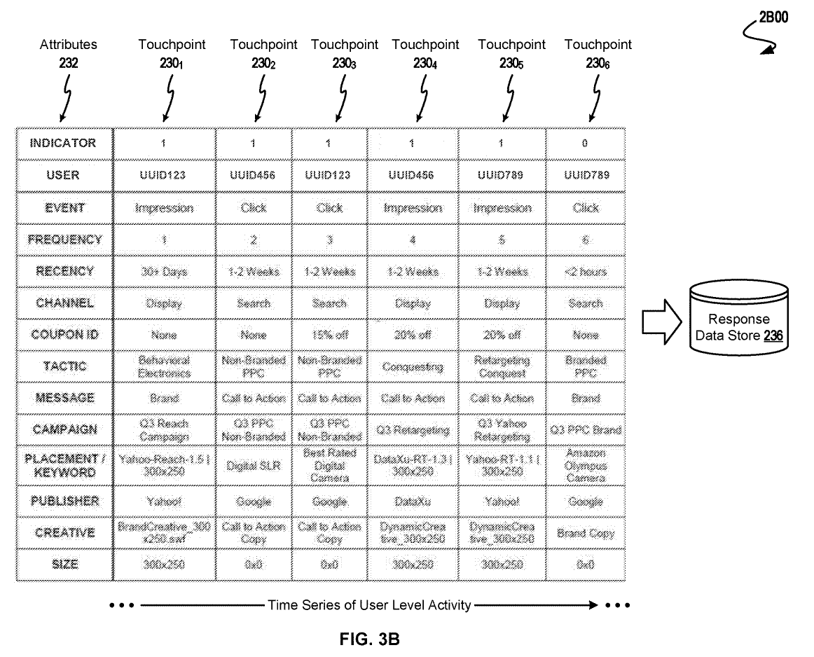

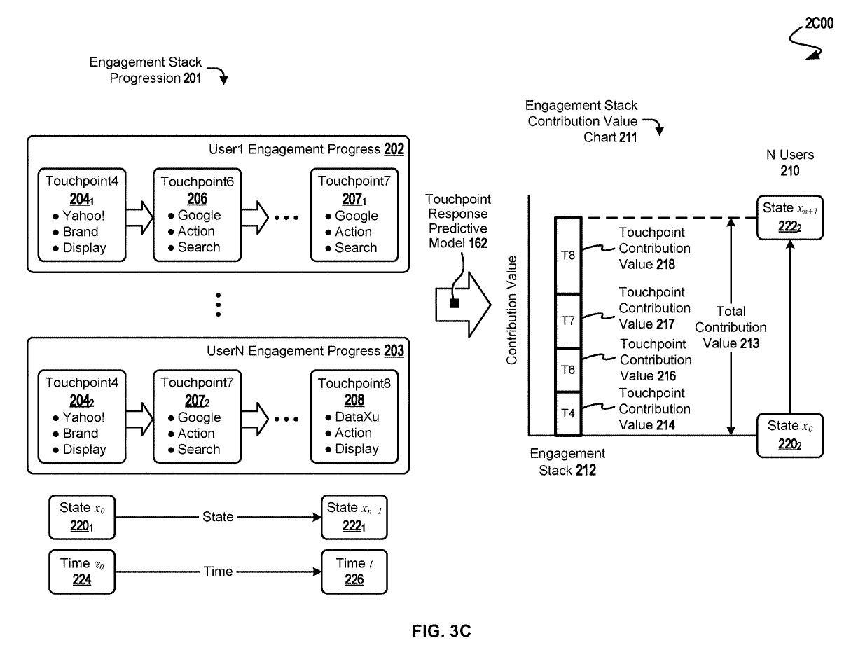

FIG. 3A presents a touchpoint response predictive modeling technique 2A00 used in systems for improving media spend management using real-time predictive modeling of touchpoint exposure effects. As an option, one or more instances of touchpoint response predictive modeling technique 2A00 or any aspect thereof may be implemented in the context of the architecture and functionality of the embodiments described herein. Also, the touchpoint response predictive modeling technique 2A00 or any aspect thereof may be implemented in any desired environment.

FIG. 3A depicts process steps (e.g., touchpoint response predictive modeling technique 2A00) used in the generation of a touchpoint response predictive model (see grouping 247). As shown, stimulus data records 172 and response data records 174 associated with one or more historical marketing campaigns and/or time periods are received by a computing device and/or system (e.g., measurement server 110) over a network (see step 242). The information associated with the stimulus data records 172 and response data records 174 can be organized into various data structures. A portion of the collected stimulus and response data can be used to train a learning model (see step 244). A different portion of the collected stimulus and response data can be used to validate the learning model (see step 246). The processes of training and/or validating can be iterated (see path 248) until the learning model behaves within target tolerances (e.g., with respect to predictive statistic metrics, descriptive statistics, significance tests, etc. ). In some cases, additional historical stimulus and response data can be collected to further train and/or validate the learning model. When the learning model has been generated, a set of touchpoint response predictive model parameters 262 (e.g., input variables, output variables, equations, equation coefficients, mapping relationships, limits, constraints, etc.) describing the learning model (e.g., touchpoint response predictive model 162) can be stored in a measurement data store 264 for access by various computing devices (e.g., measurement, server 110, management interface device 114, apportionment server 111, etc.).

Specifically, the learning model (e.g., touchpoint response predictive model 162) might be applied to certain user engagement stacks to estimate the touchpoint lifts (see step 250) contributing to conversions, brand engagement events, and/or other events. The contribution value of a given touchpoint can then be determined (see step 252) for a given segment of users and/or media channel. For example, executing step 250 and step 252 might generate a chart showing the touchpoint contributions 266 for a given segment. Specifically, a percentage contribution for a touchpoint4 (“T4”), a touchpoint6 (“T6”), a touchpoint (“T7”), and a touchpoint8 (“T8”) can be determined for the segment (e.g., all users, male users, weekend users, California users, etc.). Further, a marketing manager (e.g., manager 104₁) can use the touchpoint contributions 266 to further allocate spend among the various touchpoints by selecting associated touchpoint spend allocation values (see step 254). For example, the manager 104₁ might apply an overall marketing budget (e.g., in $US) for digital media channels to reach, the various intra-channel touchpoints. In some cases, the manager 104₁ can allocate the budget, according to the relative touchpoint contributions presented in the touchpoint contributions 266 to produce certain instances of touchpoint spend allocations 268, as shown. In other cases, the touchpoint spend allocations 268 can be automatically generated based on the touchpoint contributions 266. Embodiments of certain data structures used by the touchpoint response predictive modeling technique 2A00 are described in FIG. 3B and FIG. 3C.

FIG. 3B presents a touchpoint attribute chart 2B00 showing sample attributes associated with touchpoints of a media campaign. As an option, one or more instances of touchpoint attribute chart 2B00 or any aspect thereof may be implemented in the context of the architecture and functionality of the embodiments described herein. Also, the touchpoint attribute chart 2B00 or any aspect thereof may be implemented in any desired environment.

As discussed herein, a touchpoint (e.g., touchpoints 157) can be any occurrence where a user interacts with any aspect of a media campaign (e.g., display ad, keyword search, TV ad, etc.). Recording the various stimulation and response touchpoints associated with a marketing campaign can enable certain key performance indicators (KPIs) for the campaign to be determined. For example, touchpoint information might be captured in the stimulus data records 172, the response data records 174, the touchpoint exposure data records 168, and/or other data records for use by the herein disclosed techniques. However, some touchpoints are more readily observed than other touchpoints. Specifically, touchpoints in non-digital media channels might be not be observable at a user level and/or an individual transaction level such that summary and/or aggregate responses in non-digital channels are provided. In comparison, touchpoints in digital media channels can be captured real-time at a user level (e.g., using Internet technology). The attributes of such touchpoints in digital media channels can be structured as depicted in the touchpoint attribute chart 2B00.

Specifically, the touchpoint attribute chart 2B00 shows a plurality of touchpoints (e.g., touchpoint 230₁, touchpoint 230₂, touchpoint 230₃, touchpoint 230₄, touchpoint 230₅, and touchpoint 230₆) that might be collected and stored (e.g., in response data store 236) for various analyses (e.g., at measurement server 110, apportionment server 111, etc.). The example dataset of touchpoint attribute chart 2B00 maps the various touchpoints with a plurality of attributes 232 associated with respective touchpoints. For example, the attribute “CHANNEL” identifies the type of channel (e.g., “Display”, “Search”) that delivers the touchpoint, the attribute “MESSAGE” identifies the type of message (e.g., “Brand”, “Call to Action”) delivered in the touchpoint, and so on. More specifically, as indicated by the “EVENT” attribute, touchpoint 230₁ was an “Impression” presented to the user, while touchpoint 230₂ corresponds to an item (e.g., “Call to Action” for “Digital SLR”) the user responded to with a “Click”. Also, as represented by the “INDICATOR” attribute, touchpoint 230₁ was presented (e.g., as indicated by a “1”) in the time window specified by the “RECENCY” attribute (e.g., “30+ Days”), while touchpoint 230₆ was not presented (e.g., as indicated by a “0”) in the time window specified by the “RECENCY” attribute (e.g., “<2 hours”). For example, the “INDICATOR” can be used to distinguish the touchpoints actually exposed to a user (e.g., comprising the stimulus data records 172) as compared to planned touchpoint stimulus. In some cases, the “INDICATOR” can be used to identify responses to a given touchpoint (e.g., a “1” indicates the user responded with a click, download, etc.). Further, as indicated by the “USER” attribute, touchpoint 230₁ was presented to a user identified as “UUID123”, while touchpoint 3302 was presented to a user identified as “UUID456”. The remaining information In the touchpoint attribute chart 2B00 identifies other attribute values for the plurality of touchpoints.

A measurable relationship between one or more touchpoints and a progression through engagement and/or readiness states towards a target state is possible. Such a collection of touchpoints contributing to reaching the target state (e.g., conversion, brand engagement, etc.) can be called an engagement stack. Indeed, the foregoing touchpoint response predictive modeling technique 2A00 can be applied to such engagements stacks to determine the contribution values of touchpoints (e.g., touchpoint contributions 266) associated with certain desired responses such as conversion events, brand engagement events, and/or other events. When analyzing the impact of touchpoints on a user's engagement progression and possible execution of the target response event, a time-based progression view of the touchpoints and a stacked engagement contribution value of the touchpoints can be considered as shown in FIG. 2C.

FIG. 3C illustrates a touchpoint attribution technique 2C00. As an option, one or more instances of touchpoint attribution technique 2C00 or any aspect thereof may be implemented in the context of the architecture and functionality of the embodiments described herein. Also, the touchpoint attribution technique 2C00 or any aspect thereof may be implemented in any desired environment.

The touchpoint attribution technique 2C00 illustrates an engagement stack progression 201 that is transformed by the touchpoint response predictive model 162 to an engagement stack contribution value chart 211. Specifically, the engagement stack progression 201 depicts a progression of touchpoints experienced by one or more users. More specifically, a User1 engagement progress 202 and a UserN engagement progress 203 are shown as representative of a given audience (e.g., comprising User1 to UserN). The User1 engagement progress 202 and the UserN engagement progress 203 represent the user's progress from a state x₀ 220₁ to a state xₙ₊₁ 222₁ over a time τ₀ 224 to a time t 226. For example, the shown state x₀ 220₁ can represent an initial user engagement state (e.g., no engagement) and the state xₙ₊₁ 222₁ can represent a final user engagement state (e.g., conversion, brand engagement event, etc.). Further, the time τ₀ 224 to the time t 226 can represent a measurement time window for performing touchpoint attribution analyses. As shown in User1 engagement progress 202, User1. might experience a Touchpoint4 204₁ comprising a branding display creative published by Yahoo!. At some later moment, User1 might experience a Touchpoint6 206 comprising Google search results (e.g., search keyword “Digital SLR”) prompting a call to action. At yet another moment later in time, User1 might experience a Touchpoint 207₁ comprising Google search results (e.g., search keyword “Best Rated Digital Camera”) also prompting a call to action. Also as shown in UserN engagement progress 203, UserN might experience a Touchpoint4 204₂ having the same attributes as Touchpoint4 204₁. At some later moment, UserN might experience a Touchpoint7 207₂ having the same attributes as Touchpoint7 207₁. At yet another moment later in time, UserN might experience a Touchpoint8 208 comprising a call-to-action display creative published by DataXu. Any number of timestamped occurrences of these touchpoints and/or additional information pertaining to the touchpoints and/or user responses to the touchpoints (e.g., captured in attributes 232), can be received over the network in real time for use in generating the touchpoint response predictive model 162 and the resulting engagement stack contribution value chart 211.

The engagement stack contribution value chart 211 shows the “stack” of contribution values (e.g., touchpoint contribution value 214, touchpoint contribution value 216, touchpoint contribution value 217, and touchpoint contribution value 218) of the respective touchpoints (e.g., T4, T6, T7, and T8, respectively) of engagement stack 212. The overall contribution value of the engagement stack 212 is defined by a total contribution value 213. Various techniques (e.g., the touchpoint response predictive modeling technique 2A00) can determine the contribution value from the available touchpoint data (e.g., stimulus data records 172, response data records 174, touchpoint exposure data records 168, etc.). As shown, the contribution values indicate a relative contribution (e.g., lift) a respective touchpoint has on transitioning the subject audience segment (e.g., N Users 210) from state x₀ 220₂ to state xₙ₊₁ 222₂.

The touchpoint attribution technique 2C00 described herein can be used with the media spend scenario planner 164 and the media planning application 105 to enable a marketing manager (e.g., “user” of the media planning application 105) to simulate various media spend allocation scenarios. Such an implementation is described as pertains to FIG. 3A.

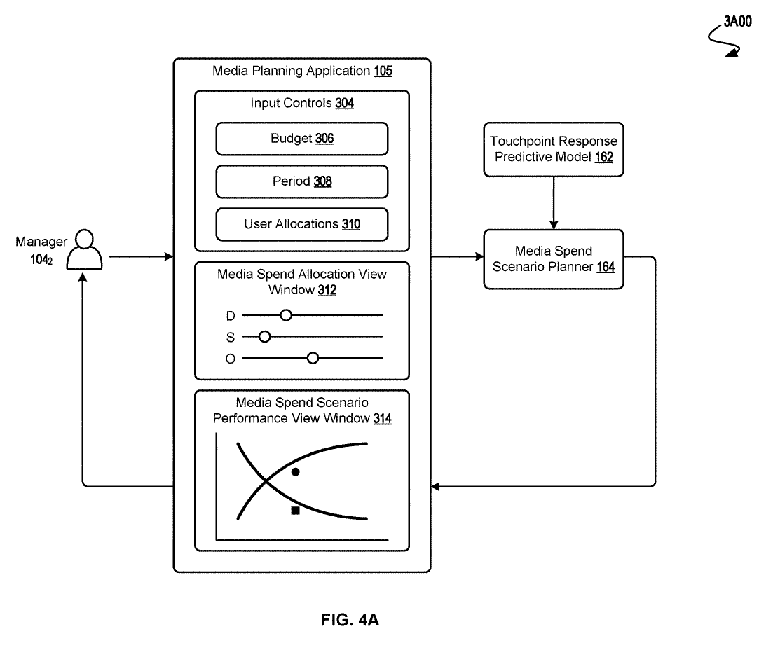

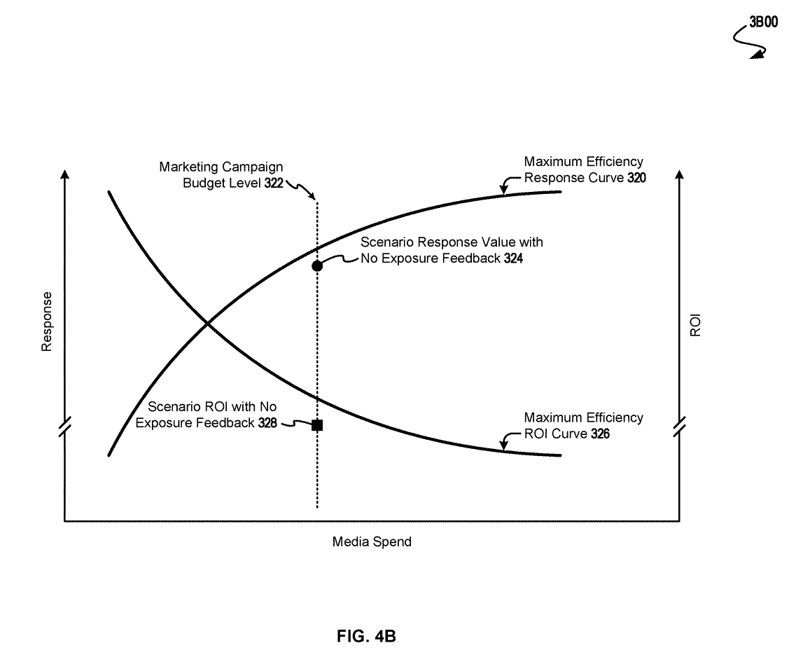

FIG. 4A depicts a user interaction environment 3A00 for selecting and viewing predicted performance results of a media spend plan. As an option, one or more instances of user interaction environment 3A00 or any aspect thereof may be implemented in the context of the architecture and functionality of the embodiments described herein. Also, the user interaction environment 3A00 or any aspect thereof may be implemented in any desired environment.

The user interaction environment 3A00 comprises the touchpoint response predictive model 162, the media, spend scenario planner 164, and the media planning application 105 described in FIG. 1A and herein. As shown, an application user (e.g., manager 104₂) can interact with the media planning application 105 to configure and/or invoke certain operations at the media spend scenario planner 164 to predict the performance of various media spend allocation scenarios. Specifically, the manager 104 interacts with the media planning application 105 using various display components (e.g., text boxes, sliders, pull-downs, widgets, view windows, etc.) that serve to capture various user inputs and/or render various information for user viewing. More specifically, the manager 1042 can input certain information using a set of input controls 304. For example, the input controls 304 can include presentation and capturing aspects of a budget 306 (e.g., a selected currency, a budget level, etc.), a period 308 (e.g., days, weeks, months, quarters, etc.), and/or user allocations 310 (e.g., selected spend allocations). Other control components are possible. Further, the manager 104₂ can view and/or interact with a media spend allocation view window 312 and a media spend scenario performance view window 314. For example, the manager 104₂ might allocate spending in a given channel using the instances of input controls 304 associated with user allocations 310 and/or using the sliders shown in the media spend allocation view window 312. Other view components are possible. In exemplary cases, the media spend scenario performance view window 314 might present various media spend allocation scenario performance results as discussed in FIG. 3B.

FIG. 4B is a depiction of media, spend plan performance results 3B00 plotted in an interactive interface.

As shown, the media spend plan performance results 3B00 can comprise one or more instances of a maximum efficiency response curve 320 and/or one or more instances of a maximum efficiency ROI curve 326. The maximum efficiency response curve 320 and the maximum efficiency ROI curve 326 can be plotted on an XY plot with a common X-axis scale (e.g., “Media Spend”) and multiple Y-axis scales (e.g., “Response”, “ROI”). In one or more embodiments, the maximum efficiency response curve 320 can represent a range of maximum response values (e.g., number of conversions) a marketing campaign might produce for a given level of media spend, at least as predicted by a media spend scenario planner. For example, the media spend scenario planner 164 can use the touchpoint response predictive model 162 and/or other information (e.g., actual touchpoints delivered, etc.) to determine (e.g., using sensitivity analyses, simulation, etc.) the response value corresponding to the most efficient media channel spend allocation mix for a givers level of media spend. Further, the maximum efficiency ROI curve 326 can represent a range of maximum ROI values (e.g., response revenue divided by touchpoint cost) a marketing campaign might produce for a given level of media spend, at least as predicted by a media spend scenario planner. For example, the media spend scenario planner 164 can use the touchpoint response predictive model 162 and/or other information (e.g., ad pricing, response revenue, etc.) to determine (e.g., using sensitivity analyses, simulation, etc.) the ROI corresponding to the most efficient media channel spend allocation mix for a given level of media spend.

The maximum efficiency response curve 320 and the maximum efficiency ROI curve 326 can be used by the marketing manager to visually assess the performance of a certain media spend allocation scenario. Specifically, as shown, the marketing manager might be asked to keep the overall media spend at or below a marketing campaign budget level 322. In such a case, the response value and ROI of a media spend allocation scenario predicted by the media spend scenario planner will lie on the level of media spend associated with the marketing campaign budget level 322 (see vertical dotted line). For example, with no implementation of the real-time touchpoint exposure effect feedback 190 according to the herein disclosed techniques, a certain media spend allocation scenario might result in a scenario response value with no exposure feedback 324 and/or a scenario ROI with no exposure feedback 328.

For some marketing campaign channels and corresponding allocation mixes, such predicted performance results can be used by the marketing manager to determine a media spend plan. In other cases, the predicted performance results need to account for the touchpoint exposure effects on performance using the herein disclosed techniques such that more accurate performance results are provided to the marketing manager for media spend planning. An example touchpoint exposure curve and corresponding performance curve that can require the implementation of the herein disclosed techniques are discussed in the following.

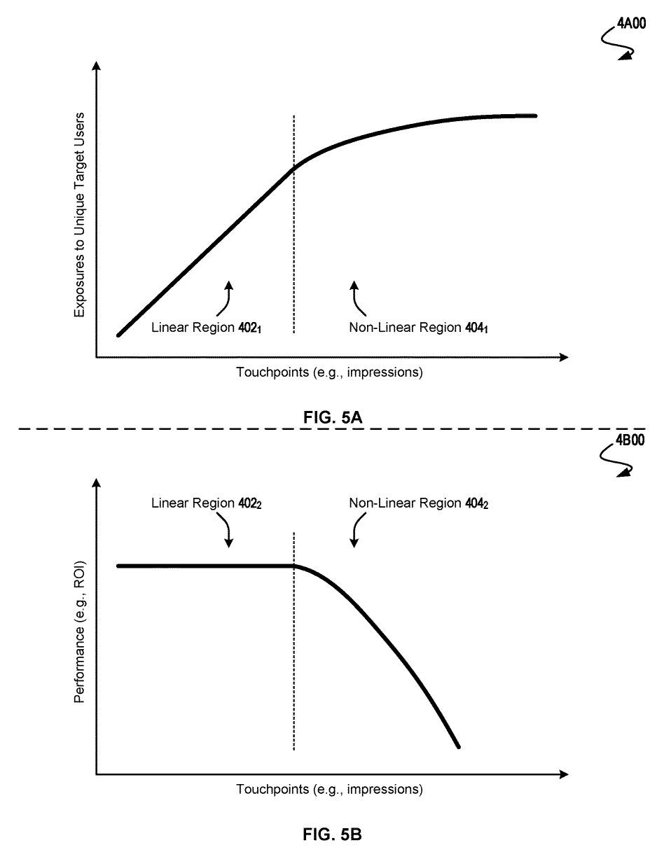

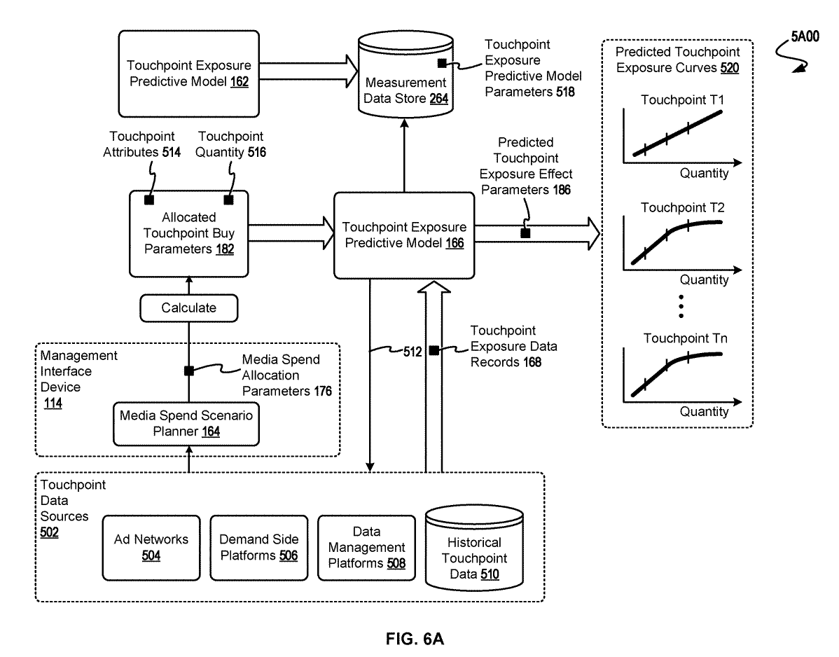

FIG. 5A illustrates a non-linear touchpoint exposure curve 4A00. As an option, one or more instances of non-linear touchpoint exposure curve 4A00 or any aspect thereof may be implemented in the context of the architecture and functionality of the embodiments described herein. Also, the non-linear touchpoint exposure curve 4A00 or any aspect thereof may be implemented in any desired environment.

The non-linear touchpoint exposure curve 4A00 is merely one example of the relationship between touchpoint exposure to unique target users (e.g., in a marketing campaign audience) and touchpoint quantity (e.g., number of impressions served). As shown, the touchpoint exposure can vary non-linearly with touchpoint quantity. Specifically, the number of unique target users reached by a given touchpoint might increase linearly with the quantity of touchpoints delivered in a linear region 402₁, whereas the number of unique target users reached by a given touchpoint might increase at a declining rate with the quantity of touchpoints delivered in a non-linear region 404₁. For example, the declining exposure rate in the non-linear region 404₁ might correspond to diminishing returns for the touchpoint associated with reach, frequency, and/or other metrics. Such non-linear touchpoint exposure characteristics can effect touchpoint performance as discussed in FIG. 5B.

FIG. 5B presents a non-linear touchpoint ROI curve 4B00 that illustrates non-linear touchpoint exposure effects on touchpoint ROI. As an option, one or more instances of non-linear touchpoint ROI curve 4B00 or any aspect thereof may be implemented in the context of the architecture and functionality of the embodiments described herein. Also, the non-linear touchpoint ROI curve 4B00 or any aspect thereof may be implemented in any desired environment.

The non-linear touchpoint ROI curve 4B00 is merely one example of the effect certain touchpoint exposure characteristics might have on touchpoint performance, such as ROI. For example, the non-linear touchpoint ROI curve 4B00 might correspond to the non-linear touchpoint exposure curve 4A00. Specifically, as shown, the non-linear touchpoint ROI curve 4B00 exhibits a constant ROI with an increase in the quantity of touchpoints delivered in a linear region 402₂. For example, the linear region 402₂ might correspond to the linear region 402₁ in FIG. 4A in which an incremental increase in touchpoints results in an increase in exposure by a fixed factor, which in turn can result in a fixed ROI (e.g., revenue per unique user divided by cost per touchpoint). The non-linear touchpoint ROI curve 4B00 further exhibits a declining ROI with an increase in the quantity of touchpoints delivered in a non-linear region 404₂. For example, the non-linear region 404 might correspond to the non-linear region 404₁ in FIG. 4A in which an increase in touchpoints results in a declining exposure, which in turn can result in a declining ROI.

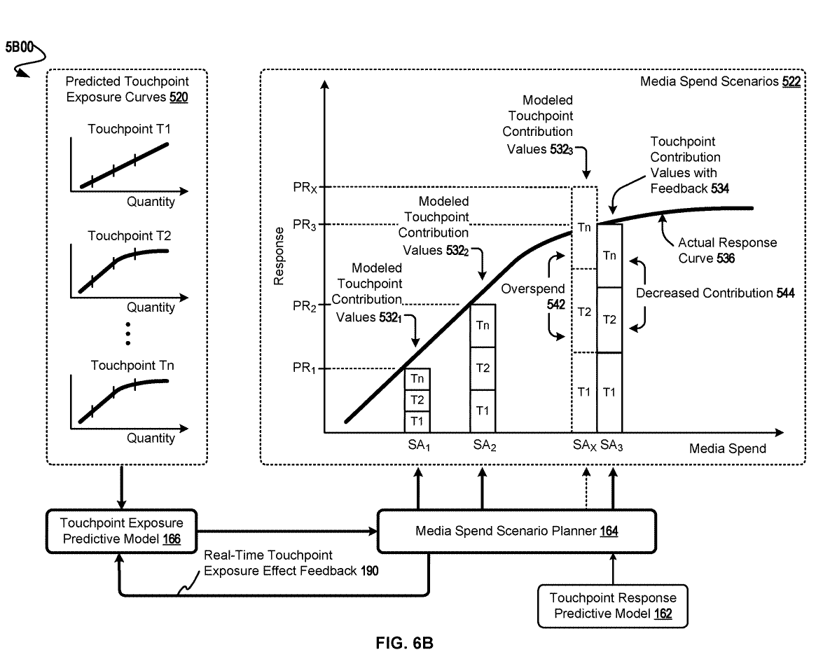

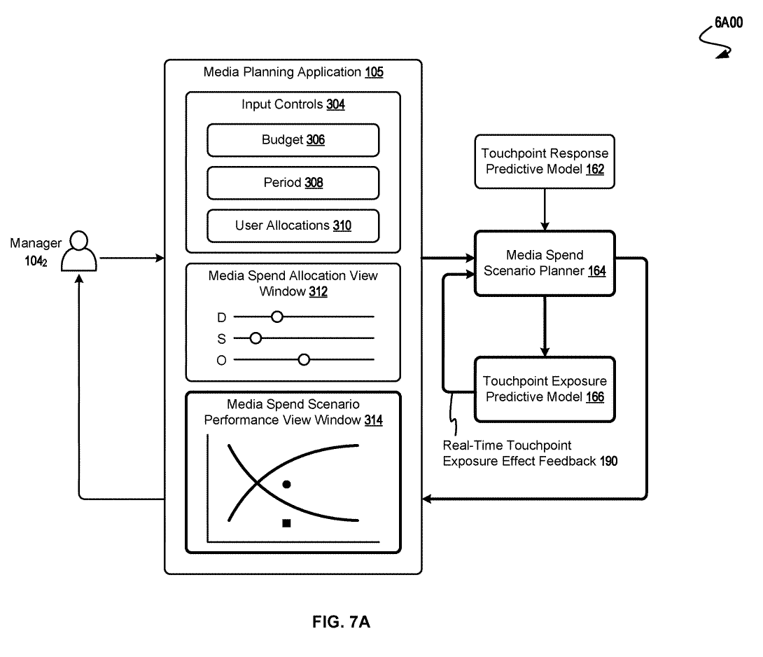

In such cases, the declining ROI resulting from the non-linear touchpoint exposure curve 4A00 can impact the performance results of a media spend, scenario planner. For example, the touchpoint response predictive model 162 used by the media spend scenario planner 164 might be generated for touchpoint quantities in the liner region of a given touchpoint exposure curve, yet the touchpoint response predictive model might not accurately model the non-linear exposure characteristics of the touchpoint. In such cases, the performance metrics predicted, by the media spend scenario planner 164 might be overestimated. The herein, disclosed, techniques can be used to estimate the effect the purchase of certain touchpoints associated with a media spend allocation scenario has on the performance (e.g., ROI) of the touchpoint buy and/or the overall media spend allocation scenario. In one or more embodiments, such techniques can implement a touchpoint exposure predictive model as discussed in FIG. 6A.

FIG. 6A presents a touchpoint exposure predictive modeling technique 5A00 used in systems for improving media spend management using real-time predictive modeling of touchpoint exposure effects. As an option, one or more instances of touchpoint exposure predictive modeling technique 5A00 or any aspect thereof may be implemented in the context of the architecture and functionality of the embodiments described herein. Also, the touchpoint exposure predictive modeling technique 5A00 or any aspect thereof may be implemented in any desired environment.

In the embodiment shown in FIG. 6A, the touchpoint exposure predictive model 166 can be formed from the touchpoint exposure data records 168 and/or other information received by a computing device and/or system (e.g., measurement server 110) over a network. The information associated with the touchpoint exposure data records 168 can be organized into various data structures. Further, the touchpoint exposure data records 168 can be received from certain instances of touchpoint data sources 502 such as ad networks 504, demand side platforms 506, data management platforms 508, sets of historical touchpoint data 510, and/or other touchpoint data sources. The touchpoint data sources 502 can be polled continuously and/or at various times using instances of data requests 512 (e.g., HTTP requests) to collect the most relevant (e.g., most recent) set of touchpoint exposure data records 168 for use in generating the touchpoint exposure predictive model 166. Specifically, a portion of the touchpoint exposure data records 168 can be used to train the touchpoint exposure predictive model 166.

The touchpoint exposure predictive model 166 processes the touchpoint exposure data records 168 to generate the predicted touchpoint exposure effect parameters 186. In some embodiments, the predicted touch point exposure effect parameters 186 modify amounts of the media spends in the media spend scenario planner 164 to account for diminishing returns in user exposure. In some embodiments, the touch point exposure data records 168 comprise information obtained from user cookies. Software to create data on user cookies captures the touchpoint encounters (stimuli data) of several users.

In some embodiment, the touchpoint exposure data records 168 are generated for over a period of time, including with time stamps to indicate a time for the touchpoint. For example, the touchpoint exposure data records 168 may comprise user cookie data (touchpoint encounters) over a first one-month period as well as user cookie data (touch point counters) over a second month period. Analyzing the touchpoint encounter data over time permits extracting relationships between the number of touchpoint impressions (i.e., how many times a user is exposed to the message or message campaign) verse exposure to unique target users, as identified through a unique identification number on the cookie. An example of touchpoint exposure data records 168, taken from “n” different time periods, may include “x₁” unique target users exposed to the touchpoint impression during the first time period (n=1), “x₂” unique target users exposed to the touchpoint in the second time period (n=2), and additional “xₙ” unique target users exposed during subsequent time periods. The touchpoint exposure predictive model 166 processes the “x” values to generate a curve depicting the number of touchpoint impressions verse exposure to unique target users. Touchpoint exposure data records 168 may contain user stimuli data for any number of time periods in order for the touchpoint exposure predictive model 166 to have sufficient data in order to calculate an accurate curve that depicts the number of touch point impressions to exposure to unique target users.

Referring again to FIG. 5A, the output of the process is depicted as a plot of the number of touchpoint impressions versus how many unique target users are exposed. The relationship in FIG. 5A shows both the linear region 402 and the nonlinear region 404, that occurs when, at a certain number of impressions, the target user group becomes saturated, and the rate of exposure to unique target users thus diminishes.

The touch point exposure predictive model 166 may also generate relationships between the number of touch point impressions versus the performance in deploying the message (i.e., return on investment “ROI”). For these embodiments, the touchpoint exposure data records 168 further comprises data for the variable, “media spend.” As shown in FIG. 5B, when the number of impressions of touchpoints is lower (left side of the curve), then the ROI rate remains constant (i.e., increasing the number of impressions also increases the effectiveness of the campaign, thus maintaining a constant performance metric to media spend verse response). However, as the number of touchpoint impressions increases, the performance drops off dramatically as shown in the non-linear region 404 of FIG. 5B.

As discussed above, the predicted touch point exposure effect parameters 186 are used to modify scenario, submitted by the user of the media spend scenario planner 164, to account for diminishing returns when increasing the number of touchpoint impressions. If the user of media spend scenario planner 164 runs a scenario to increase the media spend on a message or message campaign, the predicted touchpoint. exposure effect parameters 186 adjust the response in accordance with any diminishing returns as a result of the number of impressions exposed to the users.

Further, a different portion of the touchpoint exposure data records 168 can be used to validate the touchpoint exposure predictive model 166. The processes of training and/or validating can be iterated until the touchpoint exposure predictive model 166 behaves within target tolerances (e.g., with respect to predictive statistic metrics, descriptive statistics, significance tests, etc.). In some cases, additional instances of the touchpoint exposure data records 168 can be collected (e.g., responsive to data requests 512) to further train and/or validate the touchpoint exposure predictive model 166. When the touchpoint exposure predictive model 166 has been generated, a set of touchpoint exposure predictive model parameters 518 (e.g., input variables, output variables, equations, equation coefficients, mapping relationships, limits, constraints, etc.) describing the touchpoint exposure predictive model 166 can be stored in the measurement data store 264 for access by various computing devices (e.g., measurement, server 110, management interface device 114, apportionment server 111, etc.).

Specifically, in one or more embodiments, the real-time touchpoint exposure effect, feedback 190 implemented in the herein disclosed techniques might apply to one or more instances of the allocated touchpoint buy parameters 182 as inputs to the touchpoint exposure predictive model 166. Such allocated touchpoint buy parameters 182 might comprise one or more data records (e.g., key-value pairs) corresponding to instances of touchpoint attributes 514, a touchpoint quantity 516, and/or other attributes. The touchpoint exposure predictive model 166 can use such inputs to produce a corresponding instance of the predicted touchpoint exposure effect, parameters 186. For example, as shown in the predicted touchpoint exposure curves 520, the predicted touchpoint exposure effect parameters 186 might comprise data characterizing curves representing touchpoint exposure over touchpoint quantity for certain touchpoints (e.g., touchpoint T1, touchpoint T2, . . . , to touchpoint Tn). For example, touchpoint T1 exhibits a linear behavior for the touchpoint quantity range shown, whereas touchpoint T2 and touchpoint Tn exhibit a non-linear behavior for the quantity range. The predicted touchpoint exposure effect parameters 186 might further comprise data characterizing the quantity of each touchpoint (e.g., see tick marks on the predicted touchpoint exposure curves 520) associated with the media spend allocation scenario represented in part by the allocated touchpoint buy parameters 182.

In one or more embodiments, the touchpoint exposure predictive model 166 described in the foregoing can be used with touchpoint response predictive model 162, the media spend scenario planner 164, and the media planning application 105 to improve media spend management using real-time predictive modeling of touchpoint exposure effects according to the herein disclosed techniques. Such an implementation is described as pertains to FIG. 6B.

FIG. 6B presents a touchpoint exposure effect feedback application technique 5B00 used in systems for improving media spend management using real-time predictive modeling of touchpoint exposure effects. As an option, one or more instances of touchpoint exposure effect feedback application technique 5B00 or any aspect thereof may be implemented in the context of the architecture and functionality of the embodiments described herein. Also, the touchpoint exposure effect feedback application technique 5B00 or any aspect thereof may be implemented in any desired environment.

The touchpoint exposure effect feedback application technique 5B00 illustrates how the herein disclosed real-time touchpoint exposure effect feedback 190 using the touchpoint exposure predictive model 166 can be applied to a set of media spend scenarios 522. Specifically, the media spend scenarios 522 depict the predicted response (e.g., PR₁, PR₂, PR₃, PRₓ) provided by the media spend scenario planner 164 for certain spend allocations scenarios (e.g., SA₁, SA₂, SAₓ, SA₃) specified by a. marketing manager (e.g., manager 104₂). An actual response curve 536 is also shown for reference.

For example, spend allocation scenario SA₁ might allocate a given media spend equally among touchpoints T1, T2, and Tn according to a scaled instance of the touchpoint contribution values provided by the touchpoint response predictive model 162 (e.g., modeled touchpoint contribution values 532₁). In this ease, as shown, the predicted response might be PR₁, which falls near the actual response curve 536. Further, spend allocation scenario SA₂ might allocate a given media spend equally among touchpoints T1, T2, and Tn according to another scaled instance of the touchpoint contribution values provided by the touchpoint response predictive model 162 (e.g., modeled touchpoint contribution values 532₂). As shown, the predicted response PR relative to spend allocation scenario SA₂ might also fall near the actual response curve 536 and scale linearly from the predicted response PR₁, indicating that the touchpoint exposure behavior of T1, T2, and Tn at such media spend levels might also be linear.

In some cases, certain spend allocation scenarios might comprise touchpoint buy quantities within a region of the respective touchpoint exposure curves that is non-linear, at least as compared to the region of the curves within which the touchpoint contribution values are modeled (e.g., in the touchpoint response predictive model 162). For example, spend allocation scenario SAₓ might allocate a given media spend equally among touchpoints T1, T2, and Tn according to a scaled instance of the modeled touchpoint contribution values (e.g., modeled touchpoint contribution values 532₃), while the corresponding predicted response PRₓ might fall far from the actual response curve 536 as compared to the relationship of PR₁ and PR₂ to the actual response curve 536. In this case, for example, referring to the predicted touchpoint exposure curves 520, touchpoint T1 might exhibit a linear exposure behavior at the touchpoint buy quantities of SAₓ, whereas touchpoint T2 and touchpoint Tn might exhibit a non-linear exposure behavior at such touchpoint buy quantities. The result of using the modeled touchpoint contribution values 532₃ (e.g., without real-time touchpoint exposure effect feedback 190) to determine the touchpoint spend allocation in SAₓ can be an overspend 542 on touchpoint T2 and touchpoint Tn. In such cases, a predicted ROI that is associated with the predicted response PRₓ might overstate the ROI as compared to an actual ROI, and such an overstated ROI might not satisfy the accuracy requirements of the marketing manager.

Using the touchpoint exposure effect feedback application technique 5B00 and other herein disclosed techniques, the predicted touchpoint exposure curves 520 and other parameters (e.g., predicted touchpoint exposure effect parameters 186) provided by the touchpoint exposure predictive model 166 can be fed back into the media spend scenario planner 164 to generate an updated set of touchpoint contribution values with feedback 534. Specifically, the touchpoint contribution values with feedback 534 provided by the real-time touchpoint exposure effect feedback 190 show a decreased contribution 544 for touchpoint T2 and touchpoint Tn due in part to the non-linear exposure behavior predicted by the touchpoint exposure predictive model 166. The spend allocation scenario SA₃ using the touchpoint contribution values with feedback 534 can then allocate a given media spend among touchpoints T1, T2, and Tn without the overspend 542 while still achieving the predicted response PR.- near the actual response curve 536.

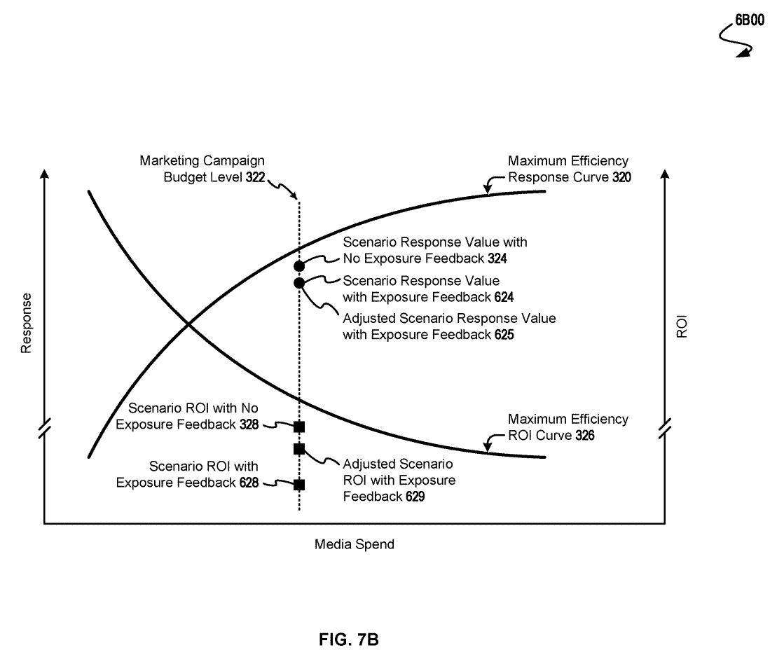

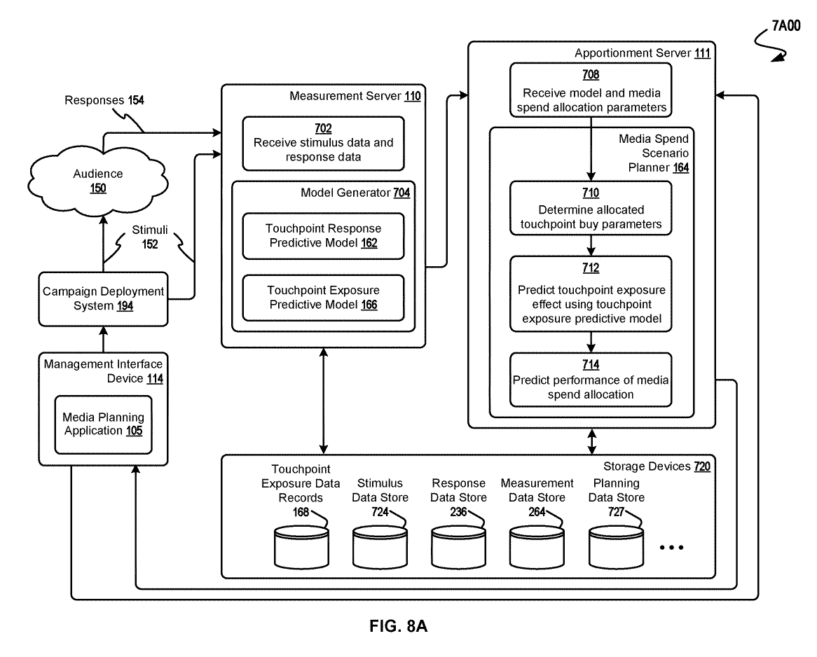

In one or more embodiments, the touchpoint exposure effect feedback application technique 5B00 and associated components can be used to improve media spend management using real-time predictive modeling of touchpoint exposure effects according to the herein disclosed techniques. Such an implementation is described as pertains to FIG. 7A.

FIG. 7A depicts a user interaction environment 6A00 for selecting and viewing predicted performance results of a media spend plan in systems for improving media spend management using real-time predictive modeling of touchpoint exposure effects. As an option, one or more instances of user interaction environment 6A00 or any aspect thereof may be implemented in the context of the architecture and functionality of the embodiments described herein.

The user interaction environment 6A00 comprises the touchpoint response predictive model 162, the touchpoint exposure predictive model 166, the media spend scenario planner 164, and the media planning application 105 described in FIG. 1A and herein. According to one or more embodiments, the media planning application 105 can further comprise the input controls 304, the media spend allocation view window 312, and. the media spend scenario performance view window 314 as described in FIG. 3A. As earlier described, the manager 104₂ can interact with the media planning application 105 to configure and/or invoke certain operations at the media spend scenario planner 164 to predict the performance of various media spend allocation scenarios. As further shown in the embodiment of FIG. 6A, the media spend scenario planner 164 and the touchpoint exposure predictive model 166 can be configured to implement the real-time touchpoint exposure effect feedback 190 according to the herein disclosed techniques. Such an implementation can enable the manager 104₂ to view the effect the purchase of certain touchpoints associated with a media spend allocation scenario has on the performance (e.g., ROI) of the touchpoints and/or the overall media spend allocation scenario. In exemplary cases, the media spend scenario performance view window 314 might present such performance effects as discussed in FIG. 7B.

FIG. 7B depicts a set of media spend plan performance results 6B00 plotted in an interactive interface as implemented in systems for improving media spend management using real-time predictive modeling of touchpoint exposure effects. As an option, one or more instances of media spend plan performance results 6B00 or any aspect thereof may be implemented in the context of the architecture and functionality of the embodiments described herein. Also, the media spend plan performance results 6B00 or any aspect thereof may be implemented in any desired environment.

As shown, the media spend plan performance results 6B00 comprises the maximum efficiency response curve 320, the maximum efficiency ROI curve 326, the marketing campaign budget level 322, the scenario response value with no exposure feedback 324, and the scenario ROI with no exposure feedback 328 as described as pertains to FIG. 3B. As further earlier described, the scenario response value with no exposure feedback 324 and the scenario ROI with, no exposure feedback 328 might be produced by the media spend scenario planner 164 with no implementation of the real-time touchpoint exposure effect feedback 190 according to the herein disclosed techniques (e.g., see FIG. 3A).

When implementing the herein disclosed techniques for improving media spend management using real-time predictive modeling of touchpoint exposure effects (e.g., see FIG. 6A), a scenario response value with exposure feedback 624 and a scenario ROI with exposure feedback 628 might be produced by the media spend scenario planner 164. In some cases, as shown, the real-time touchpoint exposure effect feedback 190 might produce a changed (e.g., lower) predicted response value (e.g., see scenario response value with no exposure feedback 324 and scenario response value with exposure feedback 624). For example, the touchpoint exposure effects provided by the touchpoint exposure predictive model 166 might adjust the predicted response generated by the touchpoint response predictive model 162 to a lower value due to an exposure saturation (e.g., reach saturation) of one or more touchpoints comprising the spend scenario. Further, the predicted ROI can be impacted (e.g., lowered) by the implementation of the real-time touchpoint exposure effect, feedback 190 since the foregoing adjusted predicted response can directly relate to the ROI value determination (e.g., compare the scenario ROI with no exposure feedback 328 to the scenario ROI with exposure feedback 628).

Using the herein disclosed techniques, a marketing manager can view a more accurate representation of the ROI (e.g., scenario ROI with exposure feedback 628) of the media spend allocation scenario. In some cases, the marketing manager can adjust the media spend allocation scenario in efforts to improve the ROI. Such an adjustment might maintain the response (e.g., to an adjusted scenario response value with exposure feedback 625) while still improving the ROI (e.g., to an adjusted scenario ROI with exposure feedback 629). Specifically, for example, an updated set of touchpoint contribution values provided by the real-time touchpoint exposure effect feedback 190 might present opportunities to the marketing manager to reduce spending on certain touchpoints yet maintain a given response, thus improving ROI. After viewing the predicted performance results of other media spend allocation scenarios, the marketing manager might conclude that the adjusted scenario response with exposure feedback 625 and the adjusted scenario ROI with exposure feedback 628 are acceptable given the marketing campaign budget level 322.

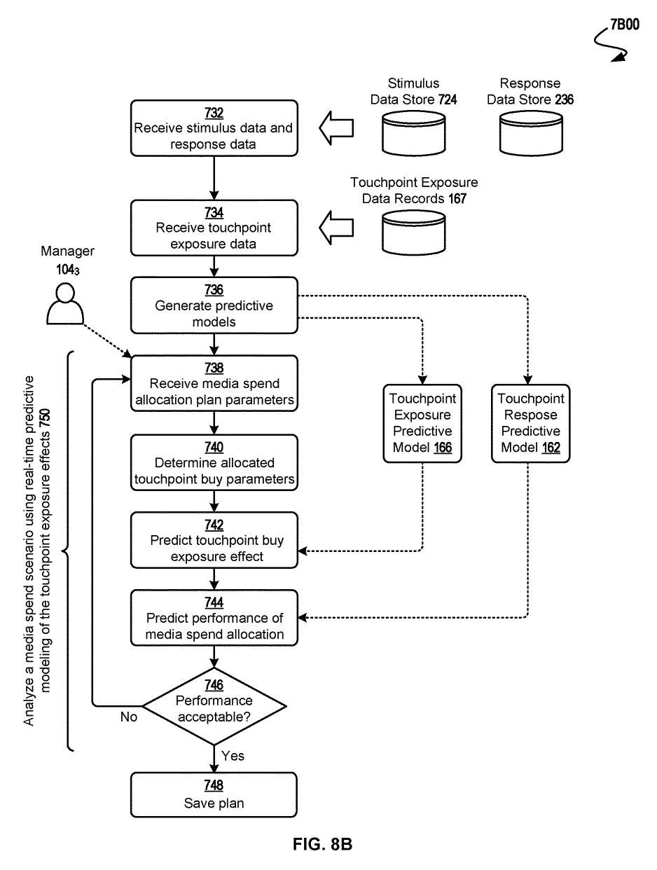

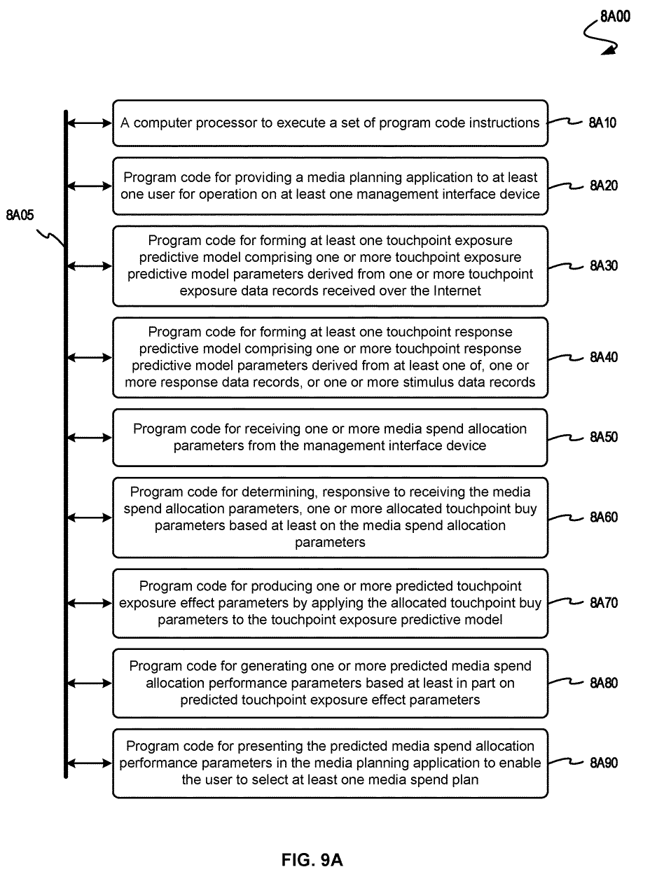

One embodiment of a subsystem for implementing the real-time touchpoint exposure effect feedback 190 and/or other herein disclosed techniques is discussed as pertains to FIG. 8A.

FIG. 8A depicts a subsystem 7A00 for improving media spend management using real-time predictive modeling of touchpoint exposure effects. As an option, one or more instances of subsystem 7A00 or any aspect thereof may be implemented in the context of the architecture and functionality of the embodiments described herein. Also, the subsystem 7A00 or any aspect thereof may be implemented in any desired environment.

As shown, subsystem 7A00 comprises certain components described in FIG. 1A and FIG. 1B. Specifically, the campaign deployment system 194 can present the stimuli 152 to the audience 150 to produce the responses 154. The measurement server 110 can receive electronic data records associated with the stimuli 152 and responses 154 (see operation 702). The stimulus data and response data can be stored in one or more storage devices 720 (e.g., stimulus data store 724, response data store 236, etc.). The measurement server 110 further comprises a model generator 704 that can use the stimulus data, response data, and/or other data to generate the touchpoint response predictive model 162. In some embodiments, the model parameters (e.g., touchpoint response predictive model parameters 262) characterizing the touchpoint response predictive model 162 can be stored in the measurement data store 264. The model generator 704 can further use the touchpoint exposure data records 168 to generate the touchpoint exposure predictive model 166. In some embodiments, the touchpoint exposure predictive model parameters 518 characterizing the touchpoint exposure predictive model 166 can be stored in the measurement data store 264.

As shown, the apportionment server 111 can receive the model parameters from the measurement server 110 and various instances of media spend allocation parameters from the management interface device 114 (see operation 708). For example, a user (e.g., marketing manager) might interact with the media planning application 105 on the management interface device 114 to specify and transmit the media spend allocation parameters (e.g., media spend allocation parameters 176) to the apportionment server 111. An instance of the media spend scenario planner 164 operating on the apportionment server 111 can determine instances of allocated touchpoint buy parameters based in part on the media spend allocation parameters (see operation 710). The media spend scenario planner 164 can further predict the touchpoint exposure effect associated with the media spend scenario represented by the media spend allocation parameters using the touchpoint exposure predictive model 166 (see operation 712). Such touchpoint exposure effects can then be included the media spend allocation scenario performance predicted by the media spend scenario planner 164 (see operation 714). In one or more embodiments, the data representing the predicted media spend allocation scenario performance (e.g., predicted media spend allocation performance parameters 178) can be stored in a planning data store 727.

The subsystem 7A00 presents merely one partitioning. The specific example shown where the measurement server 110 comprises the model generator 704, and where the apportionment server 111 comprises the media spend scenario planner 164, is purely exemplary, other partitioning is reasonable, and the partitioning may be defined in part by the volume of empirical data. In some cases, a database engine can serve to perform calculations (e.g., within or in conjunction with a database engine query). A technique for improving media spend management using real-time predictive modeling of touchpoint exposure effects implemented in such systems, subsystems, and partitionings is shown in FIG. 8B.

FIG. 8B presents a flow chart 7B00 for improving media spend management using real-time predictive modeling of touchpoint exposure effects. As an option, one or more instances of flow chart 7B00 or any aspect thereof may be implemented in the context of the architecture and functionality of the embodiments described herein. Also, the flow chart 7B00 or any aspect thereof may be implemented in any desired environment.

The flow chart 7B00 presents one embodiment of certain steps for improving media spend management using real-time predictive modeling of touchpoint exposure effects. In one or more embodiments, the steps and underlying operations shown in the flow chart 7B00 can be executed by the measurement server 110 and apportionment server 111 disclosed herein. As shown, the flow chart 7B00 can commence with receiving stimulus data and response data from various sources (see step 732), such as the stimulus data store 724 and/or the response data store 236. Further, certain touchpoint exposure data can be received from various sources (see step 734), such as the touchpoint exposure data records. Using the aforementioned received data and/or other data, various predictive models can be generated as disclosed herein (see step 736). For example, a touchpoint response predictive model 162 and touchpoint exposure predictive model 166 can be generated.

The flow chart 7B00 can continue with a set of steps for analyzing a media spend scenario using real-time predictive modeling of touchpoint exposure effects (see grouping 750). Such a set of steps might be invoked by a manager 104₃ as shown. Specifically, a set of media spend allocation parameters corresponding to a media spend allocation scenario can be received (see step 738). Various allocated touchpoint buy parameters can be determined in part from the received media spend allocation parameters (see step 740). A touchpoint buy exposure effect associated with the media spend scenario represented by the media spend allocation parameters can then be predicted using the touchpoint exposure predictive model 166 (see step 742). Such touchpoint buy exposure effects can then be included the predicted media spend allocation scenario performance (see step 744). If the predicted performance is not acceptable (see “No” path of decision 746), an adjusted set of media spend allocation parameters can be specified (e.g., by the manager 104₃) and one or more of the steps comprising the grouping 750 can be repeated. When the predicted performance for a given media spend allocation scenario is acceptable (see “Yes” path of decision 746), the accepted media spend allocation scenario can be saved as a media spend plan for immediate and/or future deployment (see step 748).

### Additional Practical Application Examples

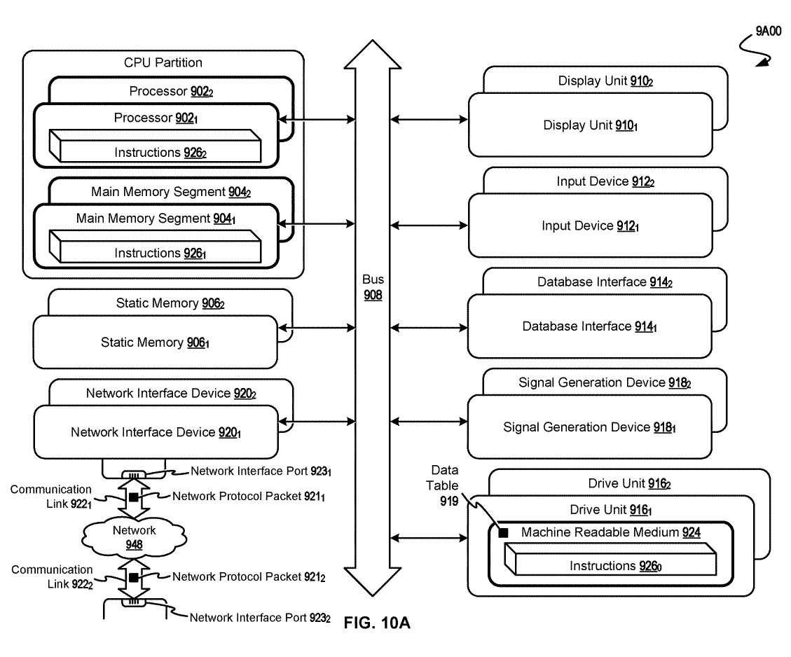

FIG. 9A is a block diagram of a system for improving media spend management using real-time predictive modeling of touchpoint exposure effects, according to an embodiment. As an option, the present system 8A00 may be implemented in the context of the architecture and functionality of the embodiments described herein. Of course, however, the system 8A00 or any operation therein may be carried out in any desired environment. The system 8A00 comprises at least one processor and at least one memory, the memory serving to store program instructions corresponding to the operations of the system. As shown, an operation can be implemented in whole or in part using program instructions accessible by a module. The modules are connected to a communication path 8A05, and any operation can communicate with other operations over communication path 8A05. The modules of the system can, individually or in combination, perform method operations within system 8A00. Any operations performed within system 8A00 may be performed in any order unless as may be specified in the claims. The shown embodiment implements a portion of a computer system, presented as system 8A00, comprising a computer processor to execute a set of program code instructions (see module 8A10) and modules for accessing memory to hold program code Instructions to perform: providing a media planning application to at least one user for operation on at least one management interface device (see module 8A20); forming at least one touchpoint exposure predictive model comprising one or more touchpoint exposure predictive model parameters derived from one or more touchpoint exposure data records received over the Internet (see module 8A30); forming at least one touchpoint response predictive model comprising one or more touchpoint response predictive model parameters derived from at least one of, one or more response data records, or one or more stimulus data records (see module 8A40), receiving one or more media spend allocation parameters from the management interface device (see module 8A50); determining, responsive to receiving the media spend allocation parameters, one or more allocated touchpoint buy parameters based at least on the media spend allocation parameters (see module 8A60); producing one or more predicted touchpoint exposure effect parameters by applying the allocated touchpoint buy parameters to the touchpoint exposure predictive model (see module 8A70); generating one or more predicted media spend allocation performance parameters based at least in part on predicted touchpoint exposure effect parameters (see module 8A80); and presenting the predicted media spend allocation performance parameters in the media planning application to enable the user to select at least one media spend plan (see module 8A90).

### Additional System Architecture Examples

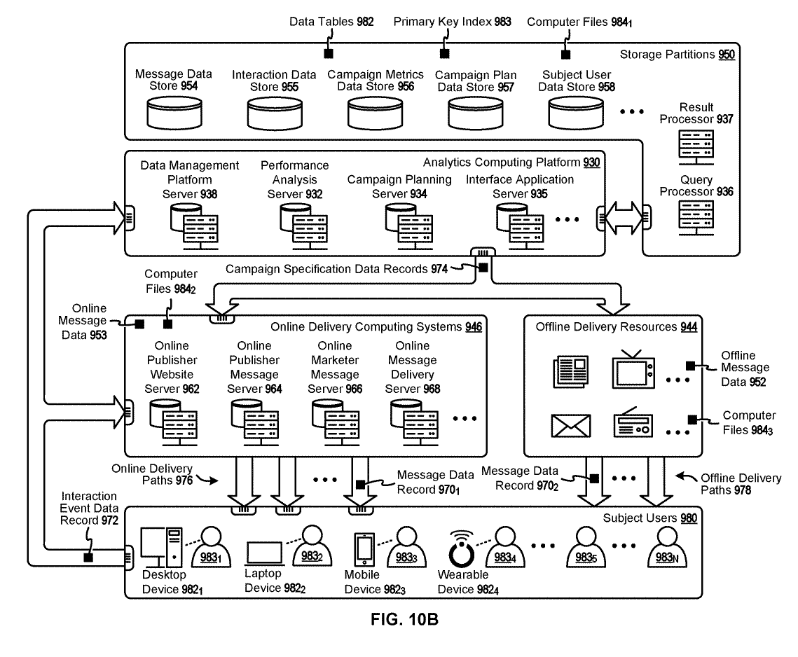

FIG. 10A depicts a diagrammatic representation of a machine in the exemplary form of a computer system 9A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 9A00 includes one or more processors (e.g., processor 902₁, processor 902₂, etc.). a main memory comprising one or more main memory segments (e.g., main memory segment 904₁, main memory segment 904₂, etc.), one or more static memories (e.g., static memory 906₁, static memory 906₂, etc.), which communicate with each other via a bus 908. The computer system 9A00 may further include one or more video display units (e.g., display unit 910₁, display unit 910₂, etc.), such as an LED display, or a liquid crystal display (LCD), or a cathode ray tube (CRT). The computer system 9A00 can also include one or more input devices (e.g., input device 912₁, input device 912₂, alphanumeric input device, keyboard, pointing device, mouse, etc.), one or more database interfaces (e.g., database interface 914₁, database interface 914₂, etc.), one or more disk drive units (e.g., drive unit 916₁, drive unit 916₂, etc.), one or more signal generation devices (e.g., signal generation device 918₁, signal generation device 918₂, etc.), and one or more network interface devices (e.g., network interface device 920₁, network interface device 920₂, etc.).

The disk drive units can include one or more instances of a machine-readable medium 924 on which is stored one or more instances of a data table 919 to store electronic information records. The machine-readable medium 924 can further store a set of instructions 926₀ (e.g., software) embodying any one, or all, of the methodologies described above. A set of instructions 926₁ can also be stored within the main memory (e.g., in main memory segment 904₁). Further, a set of instructions 926₂ can also be stored within the one or more processors (e.g., processor 902₁). Such instructions and/or electronic information may further be transmitted or received via the network interface devices at one or more network interface ports (e.g., network interface port 923₁, network interface port 923₂, etc.). Specifically, the network interface devices can communicate electronic information across a network using one or more optical links, Ethernet links, wireline links, wireless links, and/or other electronic communication links (e.g., communication link 922₁, communication link 922₂, etc.). One or more network protocol packets (e.g., network protocol packet 921₁, network protocol packet 921₂, etc.) can be used to hold the electronic information (e.g., electronic data records) for transmission across an electronic communications network (e.g., network 948). In some embodiments, the network 948 may include, without limitation, the web (i.e., the Internet), one or more local area networks (LANs), one or more wide area networks (WANs), one or more wireless networks, and/or one or more cellular networks.

The computer system 9A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 902₁, processor 902₂, etc.).

FIG. 10B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 948) using one or more electronic communication links (e.g., communication link 922₁, communication link 922₂, etc.). Such communication links may further use supporting hardware, such as modems, bridges, routers, switches, wireless antennas and towers, and/or other supporting hardware. The various communication links transmit signals comprising data, and commands (e.g., electronic data records) exchanged by the components of the data processing system, as well as any supporting hardware devices used to transmit the signals. In some embodiments, such signals are transmitted and received by the components at one or more network interface ports (e.g., network interface port 923₁, network interface port 923₂, etc.). In one or more embodiments, one or more network protocol packets (e.g., network protocol packet 921₁, network protocol packet 921₂, etc.) can be used to hold the electronic information comprising the signals.

As shown, the data processing system can be used by one or more advertisers to target a set of subject users 980 (e.g., user 983₁, user 983₂, user 983₃, user 983₄, user 983₅, to user 983_{N}) in various marketing campaigns. The data processing system can further be used to determine, by an analytics computing platform 930, various characteristics (e.g., performance metrics, etc.) of such marketing campaigns.

In some embodiments, the interaction event data record 972 comprises bottom up data suitable for computing, in performance analysis server 932, bottom up attribution. The interaction event data record 972 comprises, in part, a plurality of touchpoint encounters that represent the subject users 980 exposure to marketing message(s). Each of these touchpoint encounters comprises a number of attributes, and each attribute comprises attribute values. For example, the time of day during which the advertisement appeared, the frequency with which it was repeated, and the type of offer being advertised are all examples of attributes for a touchpoint encounter. Each attribute of a touchpoint may have a range of values. The attribute value range may be fixed or variable. For example, the range of attribute values for a day of the week attribute would be seven, whereas the range of values for a weather attribute may depend on the level of specificity desired. The attribute values may be objective (e.g., timestamp) or subjective (e.g., the relevance of the advertisement to the day's news cycle). For a “Publisher” attribute example (i.e., publisher of the marketing message), some examples of attribute values may be “Yahoo! Inc.”, “WSI.com”, “Seeking Alpha”, “NY Times Online”, “CBS Matchwatch”, “MSN Money”, “CBS Interactive”, “YuMe” and “IH Remnant.”

The interaction event data record 972 may pertain to various touchpoint encounters for an advertising or marketing campaign and the subject users 1080 who encountered each touchpoint. The interaction event data record 972 may include entries that list each instance of a consumer's encounter with a touchpoint and whether or not that consumer converted. The interaction event data record 972 may be gathered from a variety of sources, such as Internet advertising impressions and responses (e.g., instances of an advertisement being serve to a user and the user's response, such as clicking on the advertisement). Offline message data 952, such as conversion data pertaining to television, radio, or print advertising, may be obtained from research and analytics agencies or other external entities that specialize in the collection of such data.

According to one embodiment, to compute bottom up attribution in performance analysis server 932, the raw touchpoint and conversion data (e.g., interaction event data record 972 and offline message data 952) is prepared for analysis. For example, the data may be grouped according to touchpoint, user, campaign, or any other scheme that facilitates ease of analysis. All of the subject users 980 that encountered the various touchpoints of a marketing campaign are identified. The subject users 980 are divided between those who converted (i.e., performed a desired action as a result of the marketing campaign) and those who did not convert, and the attributes and attribute values of each touchpoint encountered by the subject users 980 are identified. Similarly, all of the subject users 980 that converted are identified. For each touchpoint encounter, this set of users is divided between those who encountered the touchpoint and those who did not. Using this data, the importance of each attribute of the various advertising touchpoints is determined, and the attributes of each touchpoint are ranked according to importance. Similarly, for each attribute and attribute value of each touchpoint, the likelihood that a potential value of that attribute might influence a conversion is determined.

According to some embodiments, attribute importance and attribute value importance may be modeled, using machine-learning techniques, to generate weights that are assigned to each attribute and attribute value, respectively. In some embodiments, the weights are determined by comparing data pertaining to converting user's and non-converting users. In other embodiments, the attribute importance and attribute value importance may be determined by comparing conversions to the frequency of exposures to touchpoints with that attribute relative to others. In some embodiments, logistic regression techniques are used to determine the influence of each attribute and to determine the importance of each potential value of each attribute. Any machine-learning algorithm may be used without deviating from the spirit or scope of the invention.

An attribution algorithm is used and coefficients are assigned for the algorithm, respectively, using the attribute importance and attribute value importance weights. The attribution algorithm determines the relative effect of each touchpoint in influencing each conversion given the attribute weights and the attribute value weights. The attribution algorithm is executed using the coefficients or weights. According to one embodiment, for each conversion, the attribution algorithm outputs a score for every touchpoint that a user encountered prior to converting, wherein the score represents the touchpoint's relative influence on the user's decision to convert. The attribution algorithm, which calculates the contribution of the touchpoint to the conversion, may be expressed as a function of the attribute importance (e.g., attribute weights) and attribute value lift (e.g., attribute value weights):

Credit Fashion=Σₐ₌₁ⁿf(attribute importanceₐ, attribute value liftₐ)

wherein, “a” represents the attribute and “n” represents the number of attributes. Further details regarding a general approach to bottom up touchpoint attribution are described in U.S. application Ser. No. 13/492/193 (Attorney Docket No. VISQ.P0001) entitled, “A METHOD AND SYSTEM FOR DETERMINING TOUCHPOINT ATTRIBUTION”, filed Jun. 8, 2012, now U.S. Pat. No. 9,183,562, the contents of which are incorporated by reference in its entirety in this Application.

Other operations, transactions, and/or activities associated with the data processing system are possible. Specifically, the subject users 980 can receive a plurality of online message data 953 transmitted through any of a plurality of online delivery paths 976 (e.g., online display, search, mobile ads, etc.) to various computing devices (e.g., desktop device 982₁, laptop device 982₂, mobile device 982₃, and wearable device 982₄). The subject users 980 can further receive a plurality of offline message data 952 presented through any of a plurality of offline delivery paths 978 (e.g., TV, radio, print, direct mail, etc.). The online message data 953 and/or the offline message data 952 can be selected for delivery to the subject users 980 based in part on certain instances of campaign specification data records 974 (e.g., established by the advertisers and/or the analytics computing platform 930). For example, the campaign specification data records 974 might comprise settings, rules, taxonomies, and other information transmitted electronically to one or more instances of online delivery computing systems 946 and/or one or more instances of offline delivery resources 944. The online delivery computing systems 946 and/or the offline delivery resources 944 can receive and store such electronic information in the form of instances of computer files 984₂ and computer files 984₃, respectively. In one or more embodiments, the online delivery computing systems 946 can comprise computing resources such as an online publisher website server 962, an online publisher message server 964, an online marketer message server 966, an online message delivery server 968, and other computing resources. For example, the message data record 970₁ presented to the subject users 980 through the online delivery paths 976 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 9702 presented to the subject users 980 through the offline delivery paths 978 can be transmitted as sensory signals in various forms (e.g., printed pictures and text, video, audio, etc.).

The analytics computing platform 930 can receive instances of an interaction event data record 972 comprising certain characteristics and attributes of the response of the subject users 980 to the message data record 970₁, the message data record 970₂, and/or other received messages. For example, the interaction event data record 972 can describe certain online actions taken by the users on the computing devices, such as visiting a certain URL, clicking a certain link, loading a web page that fires a certain advertising tag, completing an online purchase, and other actions. The interaction event data record 972 may also include information pertaining to certain offline actions taken by the users, such as purchasing a product in a retail store, using a printed coupon, dialing a toll-free number, and other actions. The interaction event data record 972 can be transmitted to the analytics computing platform 930 across the communications links as instances of electronic data records using various protocols and structures. The interaction event data record 972 can further comprise data (e.g., user identifier, computing device identifiers, timestamps, IP addresses, etc.) related to the users and/or the users' actions.

The interaction event data, record 972 and other data generated and used by the analytics computing platform 930 can be stored in one or more storage partitions 950 (e.g., message data store 954, interaction data store 955, campaign metrics data store 956, campaign plan data store 957, subject user data store 958, etc.). The storage partitions 950 can comprise one or more databases and/or other types of non-volatile storage facilities to store data in various formats and structures (e.g., data tables 982, computer files 984₁, etc.). The data stored in the storage partitions 950 can be made accessible to the analytics computing platform 930 by a query processor 936 and a result processor 937, which can use various means for accessing and presenting the data, such as a primary key index 983 and/or other means. In one or more embodiments, the analytics computing platform 930 can comprise a performance analysis server 932 and a campaign planning server 934. Operations performed by the performance analysis server 932 and the campaign planning server 934 can vary widely by embodiment. As an example, the performance analysis server 932 can be used to analyze the messages presented to the users (e.g., message data record 970₁ and message data record 970₂) and the associated instances of the interaction event data record 972 to determine various performance metrics associated with a marketing campaign, which metrics can be stored in the campaign metrics data store 956 and/or used to generate various instances of the campaign specification data records 974. Further, for example, the campaign planning server 934 can be used to generate marketing campaign plans and associated marketing spend apportionments, which information can be stored in the campaign plan data store 957 and/or used to generate various instances of the campaign specification data records 974. Certain portions of the interaction event data record 972 might further be used by a data management platform server 938 in the analytics computing platform 930 to determine various user attributes (e.g., behaviors, intent, demographics, device usage, etc.), which attributes can be stored in the subject user data store 958 and/or used to generate various instances of the campaign specification data records 974. One or more instances of an interface application server 935 can execute various software applications that can manage and/or interact with the operations, transactions, data, and/or activities associated with the analytics computing platform 930. For example, a marketing manager might interface with the interface application server 935 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer-implemented method for optimizing deployment of messages through a network, comprising:
storing in a computer, stimuli data for a plurality of touchpoint encounters that represent a plurality of messages exposed to a plurality of users, wherein the stimuli data comprises a plurality of attributes that characterize the deployment of the messages;
storing, in a computer, response data for the touchpoint encounters that comprise converting user data, which identifies touchpoint encounters for the users that exhibited a positive response to the message, and non-converting user data that identifies touchpoint encounters for the users that exhibited a negative response to the message;
training, using machine-learning techniques in a computer, the attributes of the stimuli data with the converting user data and the non-converting user data of the response data to generate a touchpoint response predictive model that correlates the attributes for deployment of the message to the response of the message;
generating, in a computer, a touchpoint exposure predictive model that models the relationship between the number of messages deployed and the response so as to model diminishing returns on the response due to the number of messages;
rendering, on a display of a user computer, from the touchpoint exposure predictive model, at least one predicted message deployment—response curve for the messages that depicts the effectiveness of the response to the messages as a function of one or more of the attributes of the messages;
receiving, through an interface of the riser computer, input to increase the deployment of the messages; and
rendering, on the display of the user computer, from the touchpoint exposure predictive model, a modified message deployment—response curve for the messages that incorporates diminishing returns as a result of the increase in deployment of the messages.

2. The computer-implemented method, as set forth in claim 1, further comprising touchpoint exposure data records for storing information on stimuli data that identifies a relationship between a number of touchpoint impressions and the response from the users.

3. The computer-implemented method as set forth in claim 2, wherein the touchpoint exposure data record comprises stimuli data that records a plurality of touchpoint encounters over a plurality of time periods.

4. The computer-implemented method as set forth in claim 2, further comprising generating the touchpoint exposure data records from cookies associated with the users.

5. The computer-implemented method as set forth in claim 2, wherein generating the touchpoint exposure predictive model comprises.
training, using machine-learning techniques in a computer, the touchpoint exposure data records with the response of the users to generate the touchpoint exposure predictive model that determines the number of touchpoint impressions to a number of exposures to unique target users.

6. The computer-implemented method as set forth in claim 2, wherein generating the touchpoint exposure predictive model comprises:
training, using machine-learning techniques in a computer, the touchpoint exposure data records with the response of the users to generate the touchpoint exposure predictive model that determines the number of touchpoint impressions to a return on investment performance.

7. The computer-implemented method as set forth in claim 2, wherein the relationship between a number of impressions and the response from the users comprises a linear region and a non-linear region, where the non-linear region identities diminishing returns on deploying the number of touchpoint impressions.

8. A computer readable medium, embodied in a non-transitory computer readable medium, the non-transitory computer readable medium having stored thereon a sequence of instructions which, when stored in memory and executed by a processor causes the processor to perform a set of acts, the acts comprising:
storing in a computer, stimuli data for a plurality of touchpoint encounters that represent a plurality of messages exposed to a plurality of users, wherein the stimuli data comprises a plurality of attributes that characterize the deployment of the messages,
storing, in a computer, response data for the touchpoint encounters that comprise converting user data, which identifies touchpoint encounters for the users that exhibited a positive response to the message, and non-converting user data that identifies touchpoint encounters for the users that exhibited a negative response to the message;
training, using machine-learning techniques in a computer, the attributes of the stimuli data with the converting user data and the non-converting user data of the response data to generate a touchpoint response predictive model that correlates the attributes for deployment of the message to the response of the message;
generating, in a computer, a touchpoint exposure predictive model that models the relationship between the number of messages deployed and the response so as to model diminishing returns on the response due to the number of messages;
rendering, on a display of a user computer, from the touchpoint exposure predictive model, at least one predicted message deployment—response curve for the messages that depicts the effectiveness of the response to the messages as a function of one or more of the attributes of the messages;
receiving, through an interface of the user computer, input to increase the deployment of the messages; and
rendering, on the display of the user computer, from the touchpoint exposure predictive model, a modified message deployment—response curve for the messages that incorporates diminishing returns as a result of the increase in deployment of the messages.

9. The computer readable medium as set forth in claim 8, further comprising touchpoint exposure data records for storing information on stimuli data that identifies a relationship between a number of touchpoint impressions and the response from the users.

10. The computer readable medium as set forth in claim 9, wherein the touchpoint exposure data record comprises stimuli data that records a plurality of touchpoint encounters over a plurality of time periods.

11. The computer readable medium as set forth in claim 9, further comprising generating the touchpoint exposure data records from cookies associated with the users.

12. The computer readable medium as set forth in claim 9, wherein generating the touchpoint exposure predictive model comprises:
training, using machine-learning techniques in a computer, the touchpoint exposure data records with the response of the users to generate the touchpoint exposure predictive model that determines the number of touchpoint impressions to a number of exposures to unique target users.

13. The computer readable medium as set forth in claim 9, wherein generating the touchpoint exposure predictive model comprises:
training, using machine-learning techniques in a computer, the touchpoint exposure data records with the response of the users to generate the touchpoint exposure predictive model that determines the number of touchpoint impressions to a return on investment performance.

14. The computer readable medium as set forth in claim 9, wherein the relationship
between a number of impressions and the response from the users comprises a linear region and a non-linear region, where the non-linear region identifies diminishing returns on deploying the number of touchpoint impressions.

15. A system comprising:
a storage medium, having stored thereon, a sequence of instructions;
at least one processor, coupled to the storage medium, that executes the instructions to cause the processor to perform a set of acts comprising:
storing in a computer, stimuli data for a plurality of touchpoint encounters that represent a plurality of messages exposed to a plurality of users, wherein the stimuli data comprises a plurality of attributes that characterize the deployment of the messages;
storing, in a computer, response data for the touchpoint encounters that comprise converting user data, which identifies touchpoint encounters for the users that exhibited a positive response to the message, and non-converting user data that identifies touchpoint encounters for the users that exhibited a negative response to the message;
training, using machine-learning techniques in a computer, the attributes of the stimuli data with the converting user data and the non-converting user data of the response data to generate a touchpoint response predictive model that correlates the attributes for deployment of the message to the response of the message;
generating, in a computer, a touchpoint exposure predictive model that models the relationship between the number of messages deployed and the response so as to model diminishing returns on the response due to the number of messages;
rendering, on a display of a user computer, from the touchpoint exposure predictive model, at least one predicted message deployment response curve for the messages that depicts the effectiveness of the response to the messages as a function of one or more of the attributes of the messages;
receiving, through an interface of the user computer, input to increase the deployment of the messages; and
rendering, on the display of the user computer, from the touchpoint exposure predictive model, a modified message deployment—response curve for the messages that incorporates diminishing returns as a result of the increase in deployment of the messages.

16. The system as set forth in claim 15, further comprising touchpoint exposure data records for storing information on stimuli data that identifies a relationship between a number of touchpoint impressions and the response from the users.

17. The system as set forth in claim 16. wherein the touchpoint exposure data record comprises stimuli data that, records a plurality of touchpoint encounters over a plurality of time periods.

18. The system as set forth in claim 16, further comprising generating the touchpoint exposure data records from cookies associated with the users.

19. The system as set forth in claim 16, wherein generating the touchpoint exposure predictive model comprises:
training, using machine-learning techniques in a computer, the touchpoint exposure data records with the response of the users to generate the touchpoint exposure predictive model that determines the number of touchpoint impressions to a number of exposures to unique target users.

20. The system as set forth in claim 16, wherein generating the touchpoint exposure predictive model comprises:
training, using machine-learning techniques in a computer, the touchpoint exposure data records with the response of the users to generate the touchpoint exposure predictive model that determines the number of touchpoint impressions to a return on investment performance.
